(19) United States
(12) Patent Application Publication
(10) Pub. No.: US 2025/0123468 A1
(43) Pub. Date: Apr. 17, 2025

(54) OPTICAL SYSTEM AND IMAGING DEVICE

(71) Applicant: SHENZHEN METALENX TECHNOLOGY CO.,LTD, Shenzhen (CN)

(72) Inventors: Chenglong HAO, Shenzhen (CN); Fengze TAN, Shenzhen (CN); Rui ZHU, Shenzhen (CN); Jian ZHU, Shenzhen (CN)

(73) Assignee: SHENZHEN METALENX TECHNOLOGY CO.,LTD, Shenzhen (CN)

(21) Appl. No.: 18/986,606

(22) Filed: Dec. 18, 2024

Related U.S. Application Data
(63) Continuation of application No. PCT/CN2023/097323, filed on May 31, 2023.

(30) Foreign Application Priority Data
Jun. 24, 2022 (CN) 202210724663.2
Jun. 24, 2022 (CN) 202221597876.5

(51) Int. Cl. G02B 13/00; C03C 15/00; G02B 1/11; G02B 3/00

(52) U.S. Cl. CPC G02B 13/0055; C03C 15/00; G02B 1/11; G02B 3/00; G02B 13/0045; G02B 2003/0093; G02B 2207/101

(57) ABSTRACT

An optical system and an imaging device are provided, and the optical system includes six optical elements; in order from an object side to an image side, the six optical elements include: a first lens, a second lens, a third lens, a fourth lens, a fifth lens and a sixth lens; the first lens is an aspheric refractive lens, and the second lens is a metalens; all the third lens, the fourth lens, the fifth lens and the sixth lens are refractive lenses; from the image side to the object side, there is at least one aspheric surface in the surfaces of the third lens, the fourth lens, the fifth lens and the sixth lens, and the aspheric surface has one point of inflection; the first lens has a positive focal power, and the object-side surface of the first lens is a convex surface.

### CROSS-REFERENCE TO RELATED APPLICATION

This application is a continuation of International Patent Application of PCT application serial No. PCT/CN2023/097323, filed on May 31, 2023, which claims the benefit of priority from China Application No. 202210724663.2 and No. 202221597876.5, both filed on Jun. 24, 2022. The entirety of each of the above mentioned patent applications is hereby incorporated by reference herein and made a part of this specification.

### TECHNICAL FIELD

The present disclosure relates to a field of optical image, in particular to an optical system and an imaging device.

### BACKGROUND

With the improvement of semiconductor manufacturing, the pixel size of the imaging sensor is getting smaller and smaller, which means the requirements of imaging performance for the optical system have been increasing.

However, the usual method to realize the high performance of the optical system is to increase the number of lenses in the optical system, which will inevitably increase the size and weight of the optical system.

Therefore, there is an urgent need to realize the miniaturization and lightweight of the optical system while ensuring the imaging quality.

### SUMMARY

In order to solve the above technical problem that the miniaturization of the optical system is limited by the number of lenses and the volume of the lens, an optical system, an imaging device and an electronic device are provided according to the present application.

In the first aspect, an optical system is provided, the optical system including six optical elements, wherein in order from an object side to an image side, the six optical elements include: a first lens, a second lens, a third lens, a fourth lens, a fifth lens and a sixth lens;
each of six optical elements includes an object-side surface facing towards the object plane and an image-side surface facing towards the image plane;
wherein the first lens is an aspheric refractive lens, and the second lens is a metalens; all the third lens, the fourth lens, the fifth lens and the sixth lens are refractive lenses;
and from the image side to the object side, there is at least one aspheric surface in the surfaces of the third lens, the fourth lens, the fifth lens and the sixth lens, and the aspheric surface has one point of inflection;
the first lens has a positive focal power, and the object-side surface of the first lens is a convex surface; the image-side surface of the third lens is a convex surface; the object-side surface of the fourth lens is a concave surface; both the curvature radius of object-side surface of fifth lens and the object-side surface of the sixth lens are negative;
the optical system satisfies the formulas as follows:

$$f / EPD < 3 ;$$

$$25 ° \leq HFOV \leq 55 ° ;$$

$$0.05 mm \leq {d}_{2} \leq 2 mm ;$$

$$\vert {f}_{2} \vert / f \geq 10 ;$$

wherein, f is a focal length of the optical system; EPD is an entrance pupil diameter of the optical system; HFOV is a half of the maximum field of view; d₂ is a thickness of the second lens; f₂ is a focal length of the second lens.

In one embodiment, the optical system satisfies the following condition:

$$0.35 \leq {R}_{1 o} / {f}_{1} \leq 0 \text{.58} ;$$

wherein R₁ₒ is a curvature radius of the object-side surface of the first lens; f₁ is a focal length of the first lens.

In one embodiment, the optical system satisfies the following condition:

$$( {V}_{1} + {V}_{4} ) / 2 - {V}_{3} > 20$$

wherein, V₁ is an Abbe number of the first lens; V₃ is an Abbe number of the third lens; V₄ is an Abbe number of the fourth lens.

In one embodiment, the optical system satisfies the following condition:

$$0.55 < TTL / ImgH < 0.82$$

wherein TTL is a distance between the object-side of the first lens and a image plane of the optical system; ImgH is a maximum imaging height of the optical system.

In one embodiment, the image-side of the fourth lens is a concave surface, and the optical system satisfies the following condition:

$${R}_{4 i} \times {R}_{4 o} > 0 ;$$

wherein R₄ₒ is a curvature radius of the object-side surface of the fourth lens; R₄ᵢ is a curvature radius of the image-side surface of the fourth lens.

In one embodiment, a curvature radius of the image-side surface of the sixth lens is less than 0.

In one embodiment, the first lens satisfies the following condition:

$$0.58 \leq {f}_{1} / f \leq 0.85 ;$$

wherein f₁ is a focal length of the first lens, and f is a focal length of the optical system.

In one embodiment, there is at least one aspheric refractive lens in the third lens, the fourth lens, the fifth lens and the sixth lens.

In one embodiment, the metalens comprises at least two nanostructured layers;
each of the nanostructured layers comprises a plurality of nanostructures;
the plurality of nanostructures in any two adjacent nanostructured layers are coaxial.

In one embodiment, the metalens comprises at least two nanostructured layers; the nanostructures in any adjacent nanostructured layer are non-coaxial along a direction parallel with the substrate.

In one embodiment, a period of the nanostructures in any nanostructured layers is greater than or equal to 0.3λ_{c}, and is less than or equal to 2λ_{c};
wherein, λ_{c} is a central wavelength of the second lens at the working waveband.

In one embodiment, a height of the nanostructures in any nanostructured layer is greater than or equal to 0.3λ_{c}, and is less than or equal to 2λ_{c};
wherein, λ_{c} is a central wavelength of the second lens at the working waveband.

In one embodiment, the metalens further comprises an antireflection film;
the antireflection film is set on at least one side of the substrate.

In one embodiment, the plurality of nanostructures are polarization-independent structures.

In one embodiment, the polarization-independent structures comprise cylinder structures, hollow structures, cylindrical structures, round-hole structures, hollow-round-hole structures, square column structures, square hole structures, hollow square column structures and hollow square hole structures.

In one embodiment, a working waveband of the optical system comprises a visible waveband.

In the second aspect, a manufacturing method for a metalens, wherein the manufacturing method is used to manufacture the metalens of the optical system claimed as claim 2, and the manufacturing method comprises:
S1. setting a structural material layer on the substrate;
S2. coating a photo-resist on the structural material layer, and exposing and obtaining a reference structure;
S3, etching the structural material layer into the nanostructures arranged in period according to the reference structure, so as to form the nanostructured layer;
S4. filling a filler material between the nanostructures;
S5. polishing a surface of the filler material, so as to make the surface of the filler material align with the surface of the nanostructures.

In one embodiment, the manufacturing method further comprises:
S6. repeating S1 to S5, until completing all the nanostructured layers.

In the third aspect, an imaging device is provided, wherein the imaging device comprises the optical system and an image sensor; the image sensor is set on the image plane of the optical system.

In the fourth aspect, an electronic device, wherein the electronic device includes the imaging device.

In conclusion, in the optical system provided by the present application, the first lens is configured to be an aspheric refractive lens to provide main focal power, and the second lens is configured to be a metalens. The other lenses are configured to be refractive lenses, and at least one surface of the other lenses is an aspheric surface. The length and weight of the six-lens optical system will be reduced by using the arrangement mode of “f/EPD<3; 25°≤HFOV≤55°; 0.05 mm≤d₂≤2 mm”, which realizes the miniaturization and lightweight of optical system.

The imaging device provided by the present application, the optical system provided by the present application has a smaller volume and a lighter weight, and better imaging effect, which is beneficial to combine the optical system with a larger size of the sensor and reduces the installation space of the optical system in the imaging device. In this way, the miniaturization and lightweight of the imaging device is realized.

The electronic device provided by the present application uses the imaging device provided by the application. Because the optical system in the present application has a smaller volume, lighter weight, and better imaging effect, it is beneficial to combine the optical system with the larger size of the sensor and reduce the installation space of the optical system in the imaging device. In this way, the electronic device reduces the volume and weight of the imaging device by using the imaging device, which realizes the miniaturization and lightweight of the imaging device.

### BRIEF DESCRIPTION OF THE DRAWINGS

The above and other targets, features and advantages of the example embodiment thereof by reference to the accompanying drawings.

FIG. 1 shows an optional structural schematic diagram of the optical system provided by the embodiment of the present application.

FIG. 2 shows another optional structural schematic diagram of the optical system provided by the embodiment of the present application.

FIG. 3 shows another optional structural schematic diagram of the optical system provided by the embodiment of the present application.

FIG. 4 shows another optional structural schematic diagram of the optical system provided by the embodiment of the present application.

FIG. 5 shows another optional structural schematic diagram of the optical system provided by the embodiment of the present application.

FIG. 6 shows another optional structural schematic diagram of the optical system provided by the embodiment of the present application.

FIG. 7 shows another optional structural schematic diagram of the optical system provided by the embodiment of the present application.

FIG. 8 shows another optional structural schematic diagram of the optical system provided by the embodiment of the present application.

FIG. 9 shows another optional structural schematic diagram of the optical system provided by the embodiment of the present application.

FIG. 10 shows an optional structural diagram of the metalens provided by the embodiment of the present application.

FIG. 11 shows an optional structural diagram of the nanostructure of metalens provided by the embodiment of the present application.

FIG. 12 shows another optional structural diagram of the nanostructure of metalens provided by the embodiment of the present application.

FIG. 13 shows another optional structural diagram of the nanostructure of metalens provided by the embodiment of the present application.

FIG. 14 shows another optional structural diagram of the nanostructure of metalens provided by the embodiment of the present application.

FIG. 15 shows another optional structural diagram of the nanostructure of metalens provided by the embodiment of the present application.

FIG. 16 shows another optional structural diagram of the nanostructure of metalens provided by the embodiment of the present application.

FIG. 17 shows another optional structural diagram of the nanostructure of metalens provided by the embodiment of the present application.

FIG. 18 shows another optional structural diagram of the nanostructure of metalens provided by the embodiment of the present application.

FIG. 19 shows another optional structural diagram of the metalens provided by the embodiment of the present application.

FIG. 20A and FIG. 20B show another optional structural diagram of the metalens provided by the embodiment of the present application.

FIG. 21 shows another optional structural diagram of the metalens provided by the embodiment of the present application.

FIG. 22 shows an optional phase diagram of the metalens provided by the embodiment of the present application.

FIG. 23 shows an optional transmittance diagram of the metalens provided by the embodiment of the present application.

FIG. 24 shows an optional phase diagram of the metalens provided by the embodiment of the present application.

FIG. 25 shows an optional transmittance diagram of the metalens provided by the embodiment of the present application.

FIG. 26 shows an optional flow chart of the manufacturing method of metalens provided in the embodiment of the present application.

FIG. 27 shows another optional flow chart of the manufacturing method of metalens provided in the embodiment of the present application.

FIG. 28 shows another optional flow chart of the manufacturing method of metalens provided in the embodiment of the present application.

FIG. 29 shows a schematic diagram of phase modulation of the second lens at different wavelengths in the optical system.

FIG. 30 shows an astigmatism diagram of the optical system.

FIG. 31 shows a distortion diagram of the optical system.

FIG. 32 shows a matching degree of the wide spectrum of the second lens in the optical system.

FIG. 33 shows a schematic diagram of phase modulation of the second lens at different wavelengths in the optical system.

FIG. 34 shows an astigmatism diagram of the optical system.

FIG. 35 shows a distortion diagram of the optical system.

FIG. 36 shows a matching degree of the wide spectrum of the second lens in the optical system.

FIG. 37 shows a schematic diagram of phase modulation of the second lens at different wavelengths in the optical system.

FIG. 38 shows an astigmatism diagram of the optical system.

FIG. 39 shows a distortion diagram of the optical system.

FIG. 40 shows a matching degree of the wide spectrum of the second lens in the optical system.

FIG. 41 shows a schematic diagram of phase modulation of the second lens at different wavelengths in the optical system.

FIG. 42 shows an astigmatism diagram of the optical system.

FIG. 43 shows a distortion diagram of the optical system.

FIG. 44 shows a matching degree of the wide spectrum of the second lens in the optical system.

FIG. 45 shows a schematic diagram of phase modulation of the second lens at different wavelengths in the optical system.

FIG. 46 shows an astigmatism diagram of the optical system.

FIG. 47 shows a distortion diagram of the optical system.

FIG. 48 shows a matching degree of the wide spectrum of the second lens in the optical system.

FIG. 49 shows a schematic diagram of phase modulation of the second lens at different wavelengths in the optical system.

FIG. 50 shows an astigmatism diagram of the optical system.

FIG. 51 shows a distortion diagram of the optical system.

FIG. 52 shows a matching degree of the wide spectrum in the optical system.

FIG. 53 shows a schematic diagram of phase modulation of the second lens at different wavelengths in the optical system.

FIG. 54 shows an astigmatism diagram of the optical system.

FIG. 55 shows a distortion diagram of the optical system.

FIG. 56 shows a matching degree of the wide spectrum of the second lens in the optical system.

FIG. 57 shows a schematic diagram of phase modulation at different wavelengths in the optical system.

FIG. 58 shows an astigmatism diagram of the optical system.

FIG. 59 shows a distortion diagram of the optical system.

FIG. 60 shows a matching degree of the wide spectrum of the second lens in the optical system.

FIG. 61 shows a schematic diagram of phase modulation of the second lens at different wavelengths in the optical system.

FIG. 62 shows an astigmatism diagram of the optical system.

FIG. 63 shows a distortion diagram of the optical system.

FIG. 64 shows a matching degree of the wide spectrum of the second lens in the optical system.

### DETAILED DESCRIPTION OF DISCLOSURED EMBODIMENTS

The application is more comprehensively described below with reference to the drawings, and the embodiments are shown in the drawings. However, the present application may be implemented in many different ways and should not be construed as limited to the embodiment described herein. Instead, these embodiments are provided such that the application will be exhaustive and complete, and will fully communicate the scope of the application to those skilled in the art. The same attached drawing marks throughout indicate the same components. Furthermore, in the drawings, the thickness, ratio and size of the components are enlarged to clearly illustrate.

The term used herein is used only for the purpose of describing the specific embodiment and is not intended to be a limitation. The “one”, “a single”, “the”, “this”, “one” and “at least” used in this application do not represent a limitation on quantity, but are intended to include both singular and plural. For example, “one part” has the same meaning as “at least one part” unless the context clearly indicates otherwise. “At least one” should not be interpreted as limiting to the quantity “one”. “Or” means “and/or”. The term “and/or” includes any and all combinations of one or more of the associated listed items.

Unless otherwise limited, all terms used herein, including technical and scientific terms, have the same meaning as commonly understood by those skilled in the field. The terms defined in a jointly used dictionary shall be construed to have the same meaning as those defined in the relevant technical context, and are not interpreted in an idealized or too formal meaning, unless clearly defined in the specification.

The meaning of “include” or “comprise” specifies the nature, quantity, steps, operation, parts, parts, or combinations thereof, but does not exclude other nature, quantity, steps, operation, parts, parts, or a combination of them.

This application describes the implementation with a reference to the section diagram as an idealized embodiment. Thus, relative to illustrated shape changes as a result of, for example, manufacturing technique and/or tolerance. Therefore, the embodiments described herein should not be interpreted to be limited to specific shapes of the region as shown herein, but should include deviations from shapes due to fabrication. For example, regions shown or described as flat may typically have coarse and/or non-linear characteristics. Also, the sharp angles shown can be rounded. Thus, the regions shown in the figure are schematic in nature and their shapes are not intended to show the precise shape of the area and are not intended to limit the scope of the claim.

One embodiment according to the present application will be described with reference to the accompanying drawings below.

In the proceeding of miniaturization of optical system, it is difficult for the optical system including traditional plastic lens to make breakthroughs in thickness and large curvature due to the limitation of injection molding technology. Thus, the thickness, intervals between the lenses, and TTL for the optical system with six lenses is difficult to breakthrough. On the other hand, there are only about ten optional materials for plastic lenses, which limits the freedom of the aberration correction of the optical system. At present, although the hybrid lens of glass resin solves problems such as chromatic aberration to a certain extent, the injection molding process still greatly hinders the miniaturization and lightweight of the optical system. Today, the optical system requires an enormous effort even for every 1 millimeter of reduction of total track length of the optical system. And the existing technology of the optical system with six optical elements is limited by existing manufacturing technology, which leads to a low yield.

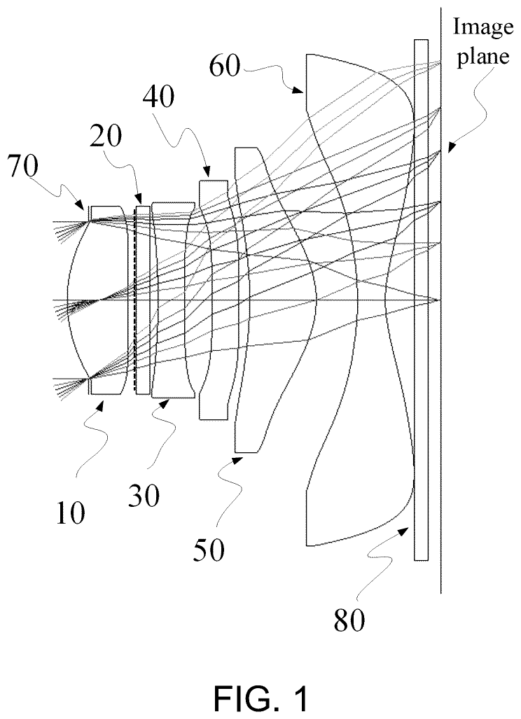

In the first aspect, an optical system is provided in the present application, as shown from FIG. 1 to FIG. 9, the optical system includes six optical elements, wherein in order from an object side to an image side, the six optical elements include: a first lens, a second lens, a third lens, a fourth lens, a fifth lens and a sixth lens; each of six optical elements includes an object-side surface facing towards the object plane and an image-side surface facing towards the image plane; wherein the first lens is an aspheric refractive lens, and the second lens is a metalens; the third lens, the fourth lens, the fifth lens and the sixth lens are refractive lenses; and from the image side to the object side, all the third lens, the fourth lens, the fifth lens and the sixth lens include at least one aspheric surface, and the aspheric surface includes one point of inflection; the first lens has a positive focal power, and the object-side surface of the first lens is a convex surface; the image-side surface of the third lens is a convex surface; the object-side surface of the fourth lens is a concave surface; both the curvature radius of object-side surface of fifth lens and the object-side surface of the sixth lens are negative; the optical system satisfies the formulas as follows:

$$f / EPD < 3 ;$$

$$25 ° \leq HFOV \leq 55 ° ;$$

$$0.05 mm \leq {d}_{2} \leq 2 mm ;$$

$$\vert {f}_{2} \vert / f \geq 10 ;$$

wherein, f is a focal length of the optical system; EPD is an entrance pupil diameter of the optical system; HFOV is a half of the maximum field of view; d₂ is a thickness of the second lens; f₂ is a focal length of the second lens.

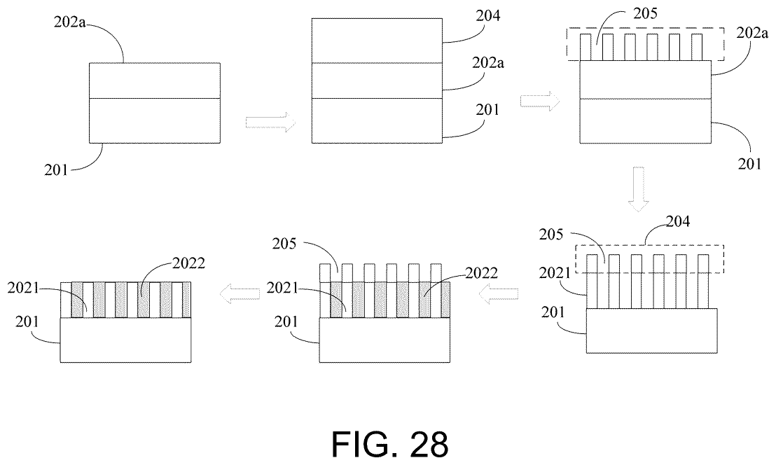

The arrangement mode is beneficial to reduce the total track length of the optical system. If exceeding the limitation of the above formulas (1-1)-(1-4), the resolution of the optical system will reduce and the TTL (total track length) of the optical system will increase. TTL (total track length) of the optical system refers to the distance between the object-side surface of the first lens and the image plane of the optical system. The surface of the refractive lens includes the object-side surface and the image-side surface. The structural diagram of the metalens is shown in FIG. 10-FIG. 28. Preferably, the second lens 20 is a metalens. Optionally, the second lens 20 is a non-planar metalens.

In one optional embodiment, the optical system satisfies the condition (2):

$$0.35 \leq {R}_{1 o} / {f}_{1} \leq 0.58 ; \qquad ( 2 )$$

wherein R₁ₒ is the current radius of the object-side surface of the first lens 10; f₁ is a focal length of the central wavelength at the working waveband.

In an optional embodiment, the optical system further satisfies condition (3) provided by the present embodiment:

$$( {V}_{1} + {V}_{4} ) / 2 - {V}_{3} > 20 ; \qquad ( 3 )$$

Wherein V₁ is an Abbe number of the first lens; V₃ is an Abbe number of the third lens; V₄ is an Abbe number of the fourth lens. The optical system satisfying condition (3) can reduce the volume of the optical system, and improve the edge imaging quality of the optical system to avoid the darkness around the edge of the imaging. And this arrangement will be beneficial to compress the TTL of the optical system.

In an optional embodiment, the optical system further satisfies condition (4) provided by the present embodiment:

$$0.55 < ImgH / TTL < 0 \text{.82} ; \qquad ( 4 )$$

ImgH is a maximum imaging height of the optical system. The maximum imaging height refers to half of the diagonal length of the effective sensing area of the electronic image sensor. TTL is a total track length of the optical system, that is, the distance between the object-side surface of the first lens and the image plane of the optical system.

In an optional embodiment, the image-side surface of the fourth lens is a concave surface, and the optical system satisfies the following condition:

$${R}_{4 i} \times {R}_{4 o} > 0 ; \qquad ( 5 )$$

wherein R₄ₒ is a curvature radius of the object-side surface of the fourth lens; R₄ᵢ is a curvature radius of the image-side surface of the fourth lens. That is, both the object-side surface and the image-side surface of the fourth lens 40 are concave surfaces. And the product of the object-side surface and the image-side surface of the fourth lens 40 is greater than 0.

In an optional embodiment, the optical system further satisfies:

$$0.58 \leq {f}_{1} / f \leq 0.85 ; \qquad ( 6 )$$

wherein f₁ is a focal length of the first lens, and f is a focal length of the optical system. The ratio of the focal length of the first lens 10 to the focal length of the optical system satisfies condition (6), which is beneficial to compress the TTL of the optical system.

In an optional embodiment, there is at least one aspheric refractive lens in the third lens, the fourth lens, the fifth lens and the sixth lens. In one embodiment, in the optical system provided by the present application, all the third lens, the fourth lens, the fifth lens and the sixth lens are aspheric refractive lenses.

In the optical system provided by the present application, the aspheric surfaces in the object-side surface and image-side surface of all lenses except the second lens 20 are shown in condition (7):

$$z = \frac{{Cr}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{12} + {Fr}^{14} + {Gr}^{16} + {Hr}^{18} + {Jr}^{20}$$

z represents the surface vector parallel to z axis, z axis is an optical axis of the optical system, c is the central curvature radius of the aspheric surface, k is a constant of center of quadric surface, A˜J are higher order coefficients.

In some optional embodiments, the optical system further comprises an aperture slot (STO) 70. Theoretically, the aperture slot 70 may be disposed on one side of any lens in the optical system. Optionally, the aperture slot 70 of the optical system of the present embodiment is provided on a side near the object side of the first lens 10 to control the aperture of the entire optical system to prevent the aperture of the optical system being too large from preventing the miniaturization of the optical system.

In an optional embodiment, the optical system provided by the present application further includes an infrared filter 80 (IR filter). The infrared filter 80 is set between the sixth lens 60 and the image plane of the optical system. The working waveband of the optical system is a visible waveband, and the infrared filter 80 is beneficial to filter the lights at the infrared waveband to improve the imaging quality, which also can avoid the image sensor being damaged by burning. It is also beneficial to reduce the imaging distortion of the optical system and improve the imaging quality of the optical system.

Next, the metalens (that is, the second lens 20) is described in detail. It should be understood that the metalens is an application of the metasurface. And the metalens includes a substrate 201 and a nanostructured layer 202; and the nanostructured layer 202 is set on at least one side of the substrate; and the number of the nanostructured layer is greater than or equal to 1; each layer of the nanostructured layers includes a plurality of nanostructures 2022, and the plurality of nanostructures 2022 are arranged in a period.

According to the embodiment of the present application, optionally, the period of the nanostructures in any nanostructured layers is greater than or equal to 0.3λ_{c}, and is less than or equal to 2λ_{c}; and λ_{c} is a central wavelength of the second lens at the working waveband.

According to the embodiment of the present application, optionally, a height of the nanostructures in any nanostructured layer is greater than or equal to 0.3λ_{c}, and is less than or equal to 5λ_{c}; and λ_{c} is a central wavelength of the second lens at the working waveband.

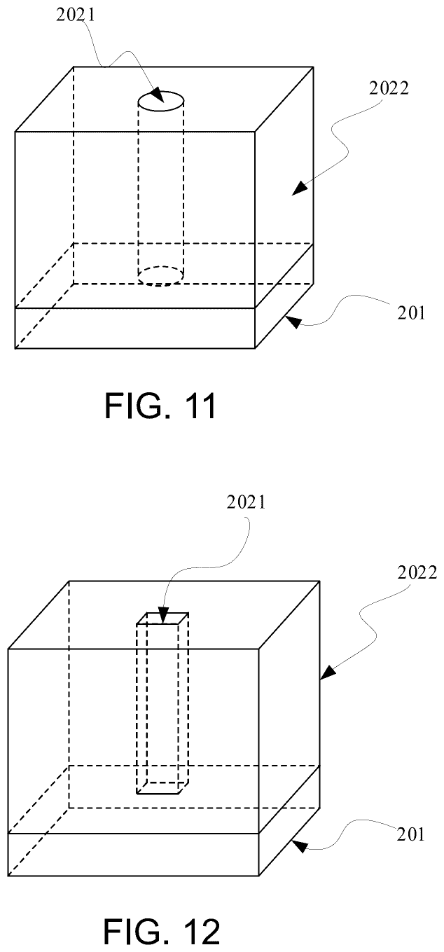

FIG. 11 and FIG. 12 show a perspective view of the nanostructure 2022 in any layer of the nanostructured layer 202 in the second lens 20. Optionally, FIG. 11 is a cylindrical structure. Optionally, the nanostructure 2022 in FIG. 12 is a positive square cylindrical structure. Optionally, as shown in FIG. 11 and FIG. 12, the metalens also includes a filler material 2022, and the filler material 2022 filled between nanostructures 2022 and the filler material 2022 is less than 0.01. Optionally, the filler material 2022 includes air or other transparent or translucent materials at the working waveband. According to the embodiment of the present application, the absolute value of the difference between the refractive index of the material 2022 and the refractive index of the nanostructure 2022 should be greater than or equal to 0.5. When the metalens provided by the embodiment of the present application have at least two layers of the nanostructured layer 202, the filler material 2022 in the nanostructured layer 202 farthest from the substrate 201 may be air.

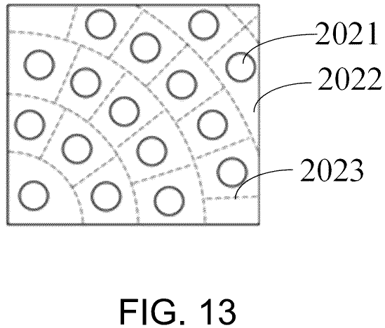

In some optional embodiments of the present application, as shown in FIG. 13 to FIG. 15, any layer of the nanostructured layer 202 includes an array arrangement of the nanostructured layer 202. The unit cell 2023 is a dense packing pattern provided with the nanostructure 2022. The nanostructure 2022 may be set on the vertice or/and center of the dense packing pattern. In the embodiment of the present application, a dense packing pattern refers to one or more figures that can fill the entire plane without gaps or overlaps.

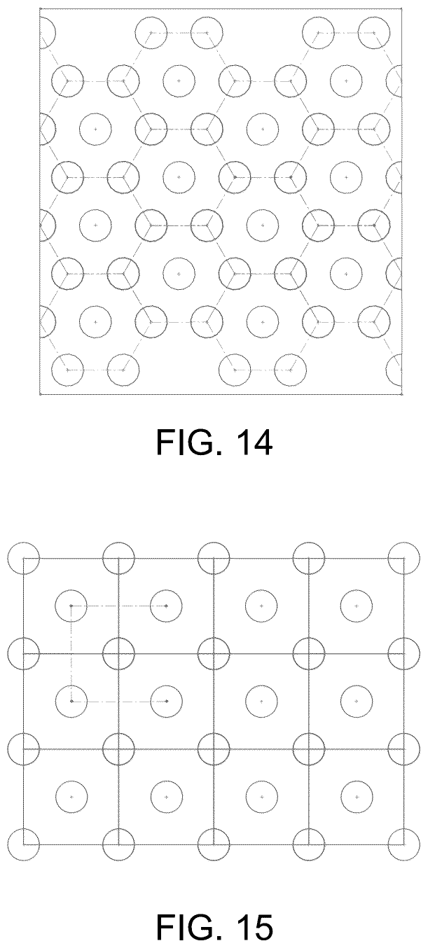

As shown in FIG. 13, according to the embodiment provided by the present application, the unit cells may be arranged in a fan-shaped array. As shown in FIG. 14, the unit cell may be arranged in a regular hexagon. In addition, the unit cell 2023 may be arranged in a regular square array. And those skilled in the field should understand that the unit cell 203 may be arranged in other shapes, and all the modifications are covered within the scope of this application.

Optionally, the wide-spectrum phase of unit cell 203 and the working waveband of the metalens also satisfy:

$$- \frac{69 rad}{μ m} \leq \frac{d φ ( r = {r}_{0} , λ )}{d λ} \leq - 5 rad / μm ; \qquad ( 8 )$$

r is a radial coordinates of the metalens; r₀ is a distance between any position on the metalens and the center of the metalens; λ is a working wavelength of the metalens.

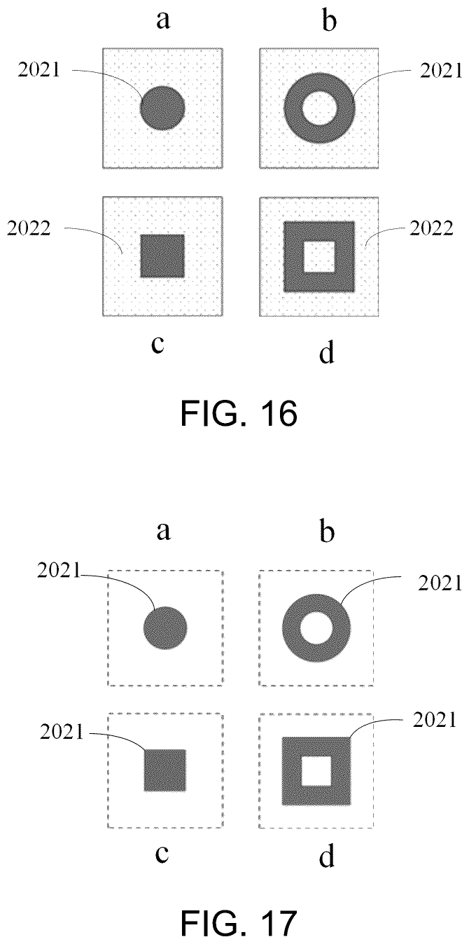

In one embodiment, the nanostructures 2022 provided by the present embodiment may be polarization-independent structures, and the polarization-independent structures apply a propagation phase to the incident lights. The embodiments as shown in FIG. 16 to FIG. 18, the polarization-independent structures include cylinder structures, hollow structures, cylindrical structures, round-hole structures, hollow-round-hole structures, square column structures, square hole structures, hollow square column structures and hollow square hole structures.

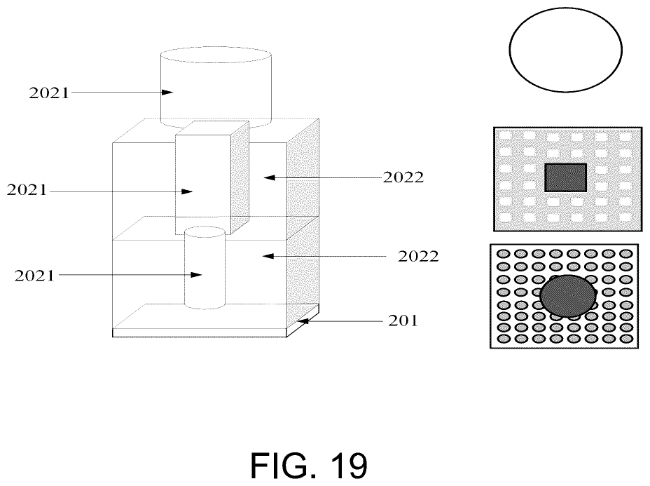

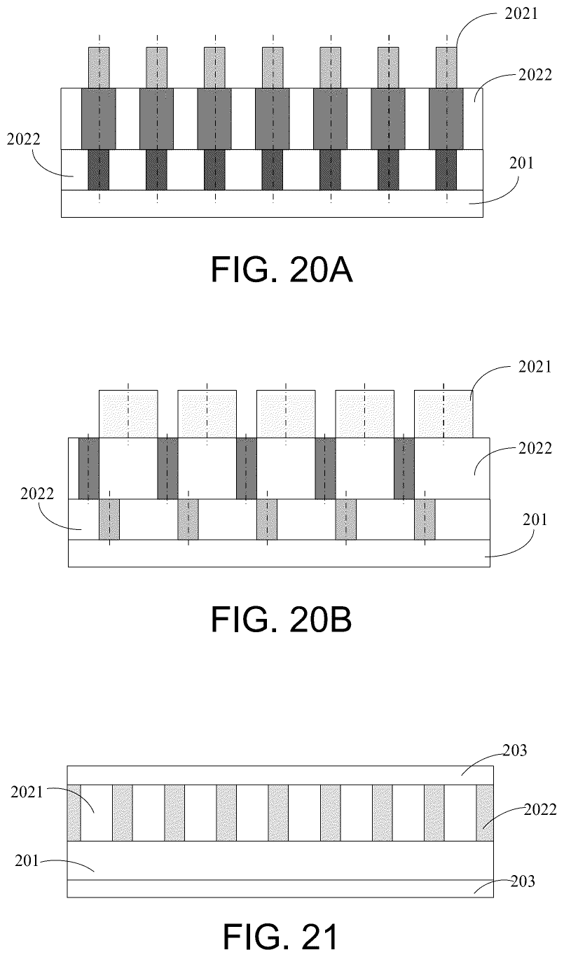

Preferably, as shown in FIG. 19, the present application provides a second lens 20 including at least two nanostructured layers 202. Optionally, as shown in FIG. 20A, the plurality of nanostructures in any two adjacent nanostructured layers are in a coaxial arrangement. And the coaxial arrangement refers to the period of the nanostructures in the adjacent nanostructured layer are the same; or the axis of the nanostructure 2022 at the same position in the two adjacent nanostructured layers coincides. Optionally, as shown in FIG. 20B, the nanostructures 2022 in the adjacent nanostructured layer in at least two layers of nanostructures 202 are misaligned in the direction parallel to the substrate 201 of the metalens. This arrangement is beneficial to break through the limitation of the processing on the aspect ratio of the nanostructures in the metalens, so as to achieve higher design freedom. FIG. 19 show a perspective view of an optional three-layer nanostructured layer. According to the embodiment of the present application, the shape, size, or material of the nanostructures 2022 in the adjacent nanostructured layer 202 may be the same or different.

In one embodiment, “a”-“d” in FIG. 16 shows the shape of the nanostructures 2022 including a cylinder, a hollow cylinder, a square column, and a hollow square column, and the filler material 2021 is filled around the nanostructures 2022. In FIG. 16, the nanostructure 2022 is disposed at the center of the unit cell of the regular square 203. In an optional embodiment of the present application, “a”-“d” in FIG. 17 shows the shape of the nanostructures 2022 including a cylinder, a hollow cylinder, a square column and a hollow square column, and there is no filler material 2022 filled around the nanostructures 2022. In FIG. 17, the nanostructures 2022 are disposed at the center of unit cell 203 of the regular square.

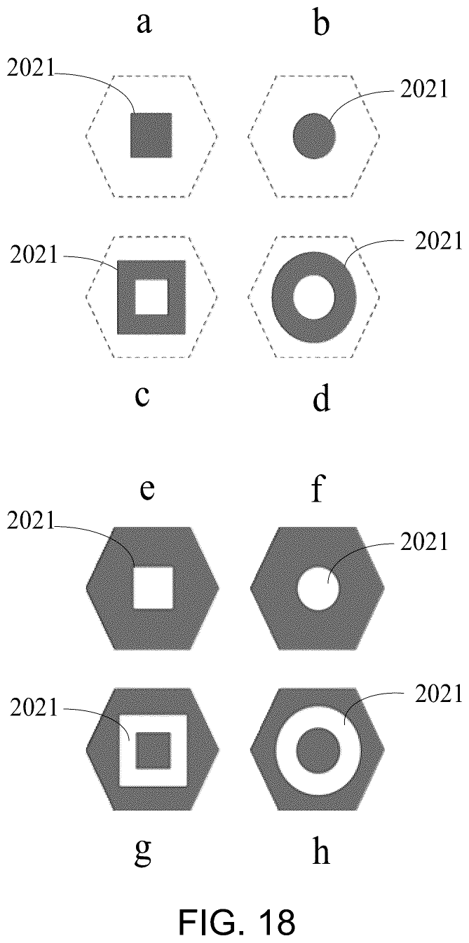

According to the embodiment of the present application, in FIG. 18, “a” to “d” shows the shape of the nanostructure 2022 including a square column, a cylinder, a hollow square column and a hollow cylinder respectively, and there is no filler material 2022 filled between the nanostructure 2022. As shown from “a” to “d” of FIG. 18, the nanostructure 2022 is disposed at the center of the unit cell 203 of the regular hexagonal shape. Optionally, “e” in FIG. 18 to “h” in FIG. 18 show the nanostructures 2022 as negative nanostructures, such as a square hole, circular, square, and circular columns. From “e” to “h” in FIG. 18, the nanostructure 2022 is a negative structure disposed at the center of the unit cell 203 of a positive hexagonal.

In one optional embodiment, as shown in FIG. 21, the metalens further includes an antireflection film 203. The antireflection film 203 is set on one side of the substrate 201 away from the nanostructured layer 202; or the antireflection film 203 is set on a side of at least one nanostructured layer 202 near the air. The antireflection film 203 is used to increase the transmittance of the incident lights and reduce the reflection of the incident lights.

According to the embodiment of the present application, the extinction coefficient of substrate 201 is less than 0.01. For example, the substrate 201 may be made of molten quartz, quartz glass, crown glass, flint glass, sapphire, crystalline silicon, amorphous silicon or hydrogenated amorphous silicon. In one embodiment, when the working waveband of the metalens is a visible waveband, the substrate 201 may be made of molten quartz, quartz glass, crown glass, flint glass, sapphire or alkaline glass. In an optional embodiment, the material of the nanostructures 2022 is different from the material of the substrate 201. Optionally, the filler material 2022 is the same as the material of the substrate 201. Optionally, the filler material 2022 is different from the material of the substrate 201.

It should be understood that in some optional embodiments of the present application, the filler material 2022 is of the same material as the nanostructure 2022. In some optional embodiments of the present application, the filler material 2022 is different from the material of the nanostructure 2022. In one embodiment, the filler material 2022 is made of a high transmittance material with an extinction coefficient less than 0.01 at the working waveband. In one embodiment, the filler material 2022 may be made of molten quartz, quartz glass, crown glass, flint glass, sapphire, crystalline silicon, amorphous silicon, or hydrogenated amorphous silicon.

Optionally, the effective refractive index range of the metalens provided by the present application embodiment is less than 2. The effective refractive index range is the maximum refractive index of the metalens minus its minimum refractive index. According to the embodiment of the present application, the phase of the metalens provided by the embodiment of the present application also meets formulas (9-1)-(9-8):

$$φ ( r , λ ) = \frac{2 π}{λ} {\sum }_{i = 1}^{N} {a}_{i} {r}^{2 i} + {φ}_{0} ( λ ) ; \qquad ( 9 - 1 )$$

$$φ ( r , λ ) = \frac{2 π}{λ} {\sum }_{i = 1}^{N} ( {a}_{i} {r}^{2 i} + \frac{{b}_{i}}{{r}^{2 i}} ) + {φ}_{0} ( λ ) ; \qquad ( 9 - 2 )$$

$$φ ( r , λ ) = \frac{2 π}{λ} {\sum }_{i = 1}^{N} \frac{{a}_{i}}{{r}^{2 i}} + {φ}_{0} ( λ ) ; \qquad ( 9 - 3 )$$

$$φ ( r , λ ) = \frac{2 π}{λ} {\sum }_{i = 1}^{N} {a}_{i} \vert {r}^{i} \vert + {φ}_{0} ( λ ) ; \qquad ( 9 - 4 )$$

$$φ ( r , λ ) = \frac{2 π}{λ} {\sum }_{i = 1}^{N} ( {a}_{i} \vert {r}^{i} \vert + \frac{{b}_{i}}{\vert {r}^{i} \vert} ) + {φ}_{0} ( λ ) ; \qquad ( 9 - 5 )$$

$$φ ( x , y , λ ) = \frac{2 π}{λ} {\sum }_{j = 1}^{N} {\sum }_{i = 1}^{j} ( {a}_{ij} {x}^{i} {y}^{j - i} + {b}_{ij} {x}^{j - i} {y}^{i} ) + {φ}_{0} ( λ ) ; \qquad ( 9 - 6 )$$

$$φ ( x , y , λ ) = \frac{2 π}{λ} ( {f}_{ML} - \sqrt{{f}_{{ML}^{2}} + {r}^{2}} ) + {φ}_{0} ( λ ) ; \qquad ( 9 - 7 )$$

$$φ ( x , y , λ ) = \frac{2 π}{λ} ( \sqrt{{f}_{{ML}^{2}} + {r}^{2}} - {f}_{ML} ) + {φ}_{0} ( λ ) ; \qquad ( 9 - 8 )$$

r is a distance between any center of nanostructure and the center of the metalens; λ is a working wavelength of the metalens; φ₀(λ) is any phase corresponding to the working wavelength; (x, y) is the coordinates of the metalens (in some cases, it can be regarded as the coordinates of the surface of the substrate 201); f_{ML} is a focal length of the metalens (the second lens 20); aᵢ and bᵢ are real coefficients. It should be noted that the phase of the metalens can be expressed in high-degree polynomials, and high-degree polynomials include both odd and even polynomials. In order not to break the rotational symmetry of the phase of metalens, in general, the phase of the even-degree polynomials is only optimized, which greatly reduces the design degree of freedom of the metalens. From the formulas (9-1) to (9-8), formulas (9-4)-(9-6) are capable of satisfying the optimization of the phase of the odd-degree polynomial without breaking its rotational symmetry, and greatly increase the optimization degree of freedom of the metalens.

Optionally, the real phase of the metalens provided by the present application can match with the ideal theoretical phase, that is, the matching degree of the wide spectrum of the metalens satisfies the formula (10) as follows:

$$η = \frac{1}{{λ}_{max} - {λ}_{min}} {\int }_{{λ}_{min}}^{{λ}_{max}} \vert exp [ i ( {φ}_{the} ( λ ) - {φ}_{real} ( λ ) ) ] \vert d λ ; \qquad ( 10 )$$

λₘₐₓ is the longest wavelength at the working waveband and λₘᵢₙ is the shortest wavelength at the working waveband. For example, λₘₐₓ=700 nm, λₘᵢₙ=400 nm. φₜₕₑ is the target theoretical phase and φᵣₑₐₗ is the real phase in the database.

### Embodiment 1

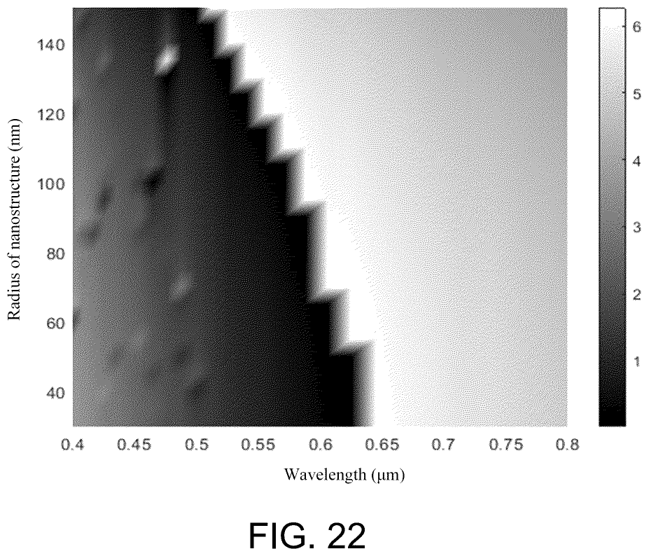

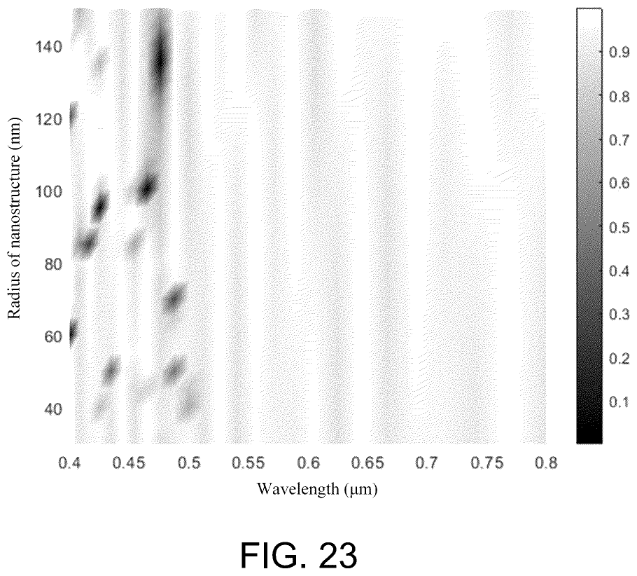

In one embodiment, the present embodiment provides a metalens. The metalens includes a substrate 201 and two nanostructured layers 202 setting on substrate 201. From the direction away from the substrate 201, the two nanostructured layers 202 are the first nanostructured layer and the second nanostructured layer. The specific parameter items are as shown in Table 1. FIG. 22 shows the phase diagram of the embodiment provided by the present application, and the horizontal coordinate of FIG. 22 is the wavelength of the incident lights, and the vertical coordinate is the radius of the nanostructures 2022. FIG. 23 shows a transmittance diagram of the metalens in embodiment 1, the horizontal coordinate of FIG. 23 is the wavelength of the incident lights, and the vertical coordinate is the radius of the nanostructures 2022.

TABLE 1

| Items | | Parameter | |
|---|---|---|---|
| Working wavelength | | Visible light | |
| Material of substrate | | Quartz glass | |
| Period of regular hexagonal | | 400 | nm |
| The first | Type of nanostructure | Cylinder | |
| nanostructured | Material of nanostructure | Silicon nitride | |
| layer | Filler material | Silicon dioxide (SᵢO₂) | |
| | Height | 700 | nm |
| | Diameter of nanostructure | 70 | nm |
| The second | Type of nanostructure | Cylinder | |
| nanostructured | Material of nanostructure | Air | |
| layer | Filler material | Silicon dioxide (SᵢO₂) | |
| | Height | 700 | nm |
| | Diameter of nanostructure | 60~340 | nm |

### Embodiment 2

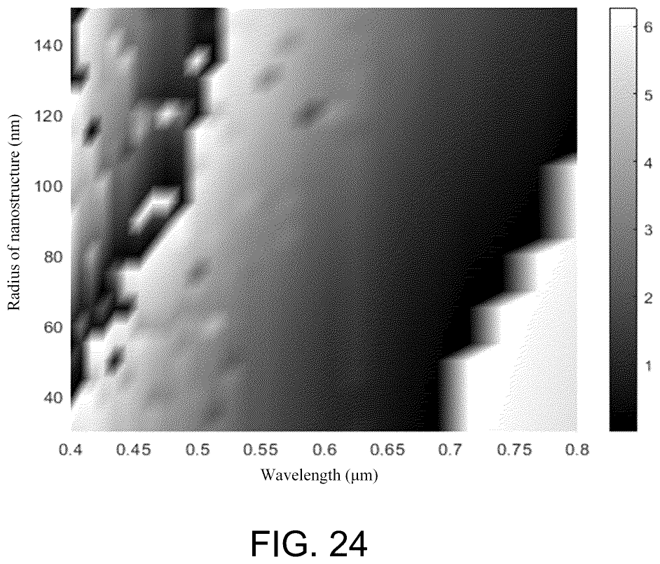

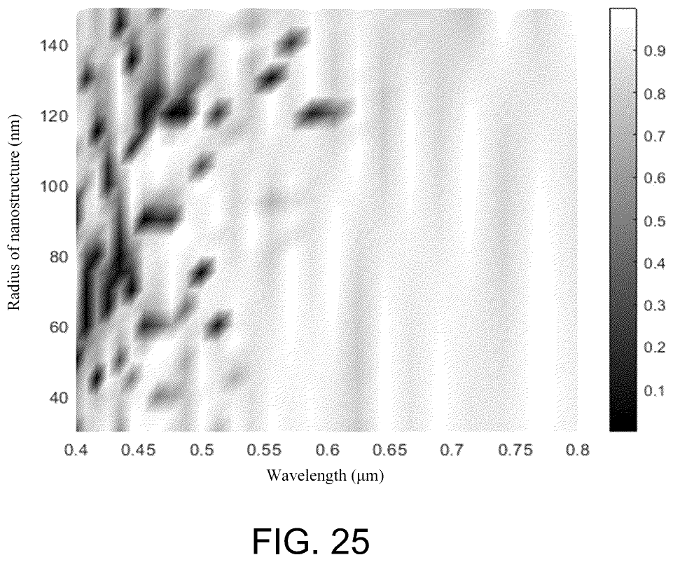

In one embodiment, the present embodiment provides a metalens. The metalens includes a substrate 201 and two nanostructured layers 202 setting on the substrate 201. The two nanostructured layers 202 from the direction away from the substrate 201 are the first nanostructured layer and the second nanostructured layer. The specific parameters are shown in Table 2. FIG. 24 shows the phase diagram of the embodiment provided by the present application, and the horizontal coordinate of FIG. 24 is the wavelength of the incident lights, and the vertical coordinate is the radius of the nanostructures 2022. FIG. 25 shows a transmittance diagram of the metalens provided by embodiment 2, and the horizontal coordinate of FIG. 25 is a wavelength of incident lights, and the vertical coordinate is a radius of nanostructures 2022.

TABLE 2

| Items | | Parameter item | |
|---|---|---|---|
| Working wavelength | | Visible light | |
| Material of substrate | | Quartz glass | |
| Period of regular hexagonal | | 400 | nm |
| The first | Type of nanostructure | Hollow circular cylinder | |
| nanostructured | Material of nanostructure | Silicon nitride | |
| layer | Filler material | Silicon dioxide (SᵢO₂) | |
| | Height | 700 | nm |
| | Inner diameter | 70 | nm |
| | Outer diameter | 220 | nm |
| The second | Type of nanostructure | Cylinder | |
| nanostructured | Material of nanostructure | Titanium dioxide | |
| layer | Filler material | Silicon dioxide (SᵢO₂) | |
| | Height | 700 | nm |
| | Diameter of nanostructure | 60~340 | nm |

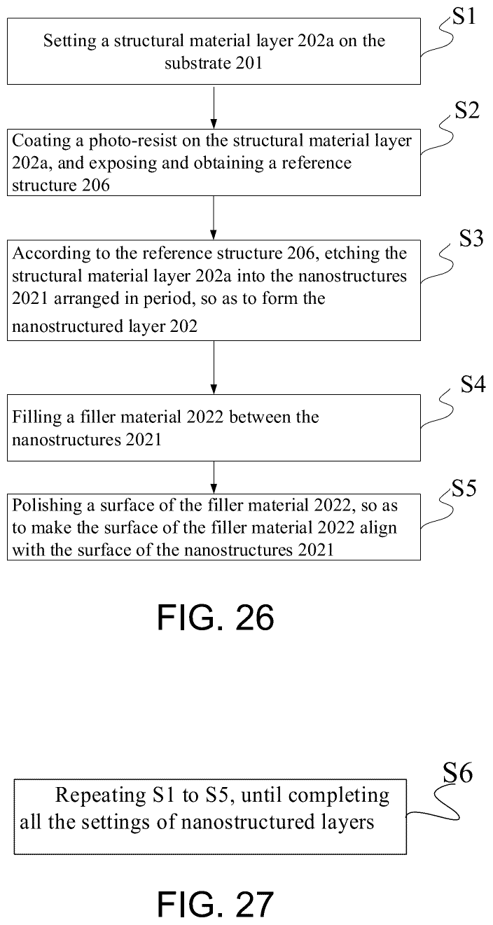

In the second aspect, the manufacturing method for the metalens is provided, and the manufacturing method is applied to the second lens (metalens) 20 in any embodiment provided by the present application. As shown in FIG. 26 to FIG. 28, the manufacturing method comprises S1-S5:
S1. setting a structural material layer 202a on the substrate 201;
S2. coating a photo-resist on the structural material layer 202a, and exposing and obtaining a reference structure 206; wherein, the structural material layer 202a is used to be manufactured into the nanostructures.
S3, etching the structural material layer 202a into the nanostructures 2022 arranged in a period according to the reference structure 206, so as to form the nanostructured layer 202;
S4. filling a filler material 2022 between the nanostructures 2022;
S5. polishing a surface of the filler material 2022, so as to make the surface of the filler material 2022 align with the surface of the nanostructures 2022.

Optionally, as shown in FIG. 27, the manufacturing method further includes:
S6. repeating S1 to S5, until completing all the nanostructured layers.

### Embodiment 3

In one embodiment, embodiment 3 provides an optical system, and the optical system is shown in FIG. 1. The optical system in order from an object side to an image side, the six optical elements include: an aperture slot (STO) 70, a first lens 10, a second lens 20, a third lens 30, a fourth lens 40, a fifth lens 50 and a sixth lens 60. As shown in FIG. 1, the infrared filter is set between the sixth lens 60 and the image plane of the optical system. The optical system satisfies conditions (1-1)-(1-4):

$$f / EPD < 3 ; \qquad ( 1 - 1 )$$

$$25 ° \leq HFOV \leq 55 ° ; \qquad ( 1 - 2 )$$

$$0.05 mm \leq {d}_{2} \leq 2 mm ; \qquad ( 1 - 3 )$$

$$\vert {f}_{2} \vert / f \geq 10 ; \qquad ( 1 - 4 )$$

f is a focal length of the optical system; EPD is an entrance pupil diameter of the optical system; HFOV is a half of the maximum field of view; d₂ is a thickness of the second lens; f₂ is a focal length of the second lens.

The specific parameters of the optical system provided by embodiment 3 are shown in Table 3-1. The curvature, thickness, refractive index, and other parameter items of each lens in the optical system are shown in Table 3-2. The aspherical coefficients of each surface of each lens in the optical system are shown in Table 3-3-1 and Table 3-3-2, and the aspheric coefficients are shown in formula (9).

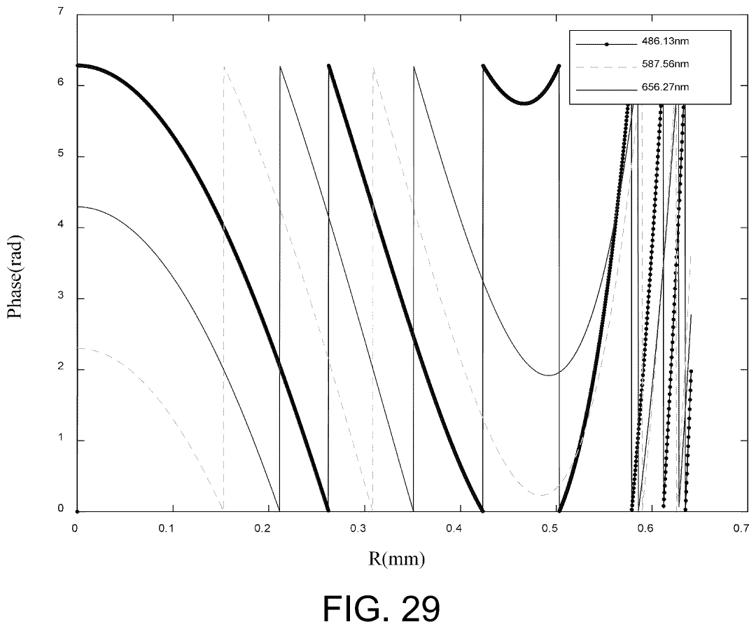

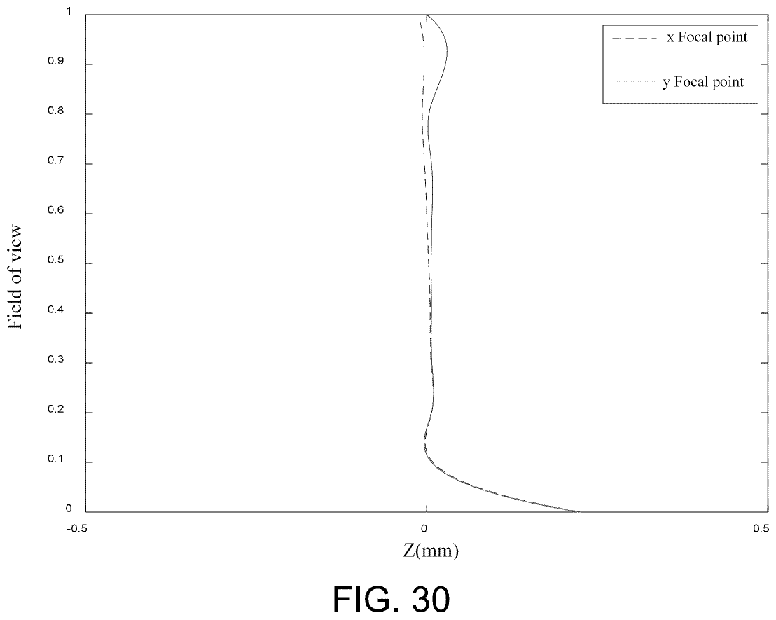

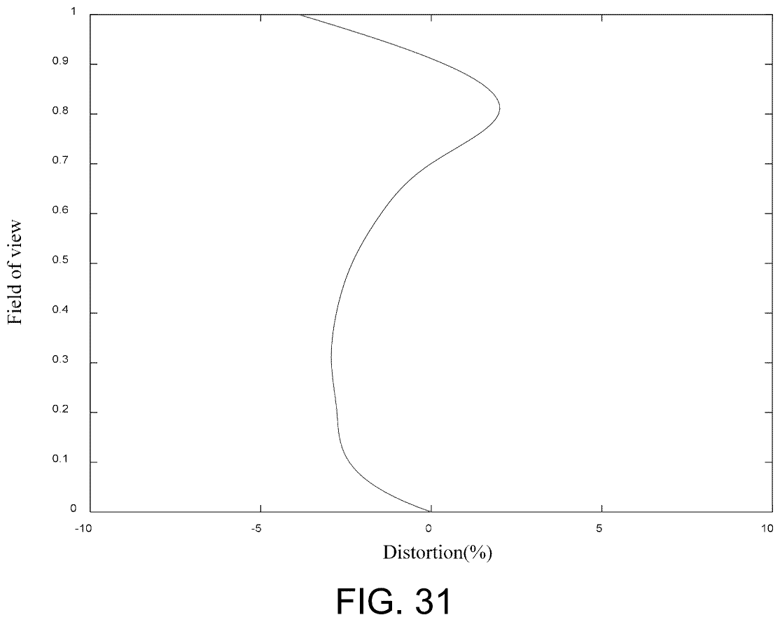

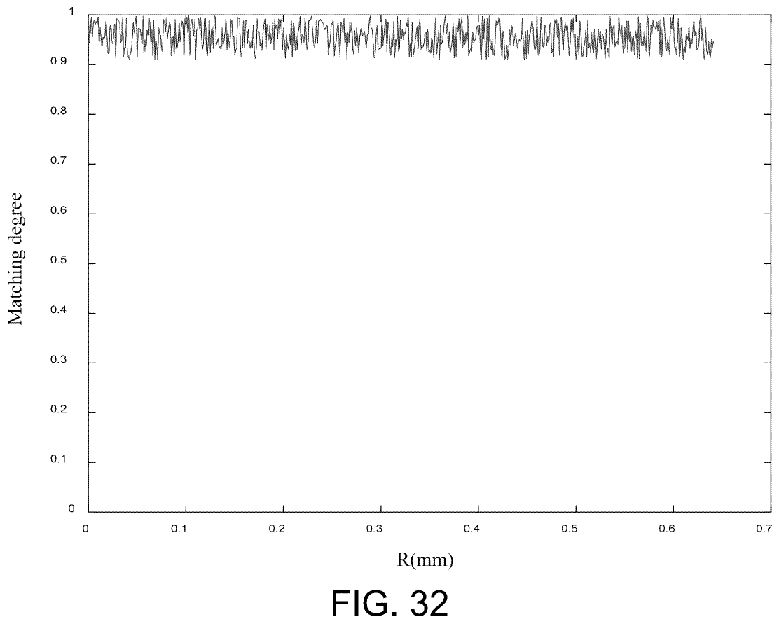

FIG. 29 shows a phase modulation diagram of the metalens in the optical system provided by embodiment 3 at the wavelength of 486.13 nm, 587.56 nm, and 656.27 nm. It can be seen in FIG. 29 that the phases cover 0-2π of the metalens at different wavelengths. FIG. 30 shows an astigmatism diagram of the optical system. According to FIG. 30, the astigmatism of the optical system at the different fields of view from 0 to 1 is less than 0.5 mm. FIG. 31 shows a distortion diagram of the optical system. According to FIG. 31, the distortion of the optical system at the different fields of view from 0 to 1 is less than 5%. FIG. 32 shows the matching degree of the wide spectrum of the metalens in the optical system in embodiment 3. According to FIG. 32, the real phase of embodiment 3 and the theoretical phase is greater than 90%. The optical system in embodiment 3 has a high MTF and has good control of astigmatism and distortion, therefore the optical system has good imaging quality.

TABLE 3-1

| Parameter item | Value | |
|---|---|---|
| Working wavelength(WL) | VIS(400-700 nm) | |
| Effective focal length(EFL) | 4 | mm |
| Field of view(2ω) | 66.4° | |
| F number | 2.85 | |
| Image height (ImgH) | 3.014 | mm |
| Total track length(TTL) | 4.2 | mm |

TABLE 3-2

| Numbered | | Radi- | Thick- | |
|---|---|---|---|---|
| surface | Surface type | us(mm) | ness(mm) | Material |
| L₁ₒ | Aspheric surface | 1.301 | 0.439 | 540000.560000 |
| L₁ᵢ | Aspheric surface | 4.023 | 0.0722 | |
| STO | Spherical surface | Infinite | 0.05 | |
| L₂ₒ | Structural surface | Infinite | 0.1 | 458000.676000 |
| | (metalens) | | | |
| L₂ᵢ | Spherical surface | Infinite | 0.05 | |
| L₃ₒ | Aspheric surface | 10.24 | 0.20 | 634000.238000 |
| L₃ᵢ | Aspheric surface | 8.200 | 0.11 | |
| L₄ₒ | Aspheric surface | −3.2581 | 0.2154 | 544000.559000 |
| L₄ᵢ | Aspheric surface | −3.8951 | 0.0706 | |
| L₅ₒ | Aspheric surface | −2.3544 | 0.6828 | 544000.559000 |
| L₅ᵢ | Aspheric surface | −1.7366 | 1.370 | |
| L₆ₒ | Aspheric surface | −1.631 | 0.2356 | 544000.559000 |
| L₆ᵢ | Aspheric surface | 27.44 | 0.225 | |
| IR filterₒ | Spherical surface | Infinite | 0.145 | 517000.642000 |
| IR filterᵢ | Spherical surface | Infinite | 0.2331 | |
| Image plane | Spherical surface | Infinite | 0 | |

TABLE 3-3-1

| Numbered surface | L₁ₒ | L₁ᵢ | L₃ₒ | L₃ᵢ | L₄ₒ | L₄ᵢ |
|---|---|---|---|---|---|---|
| K | −4.930885 | −9.967591 | −2.48E+16 | −9.967591 | −19.73647 | −21.66745 |
| A | 0.2816075 | −0.03333 | −0.056678 | −0.03333 | −0.130666 | −0.061622 |
| B | −0.219687 | −0.00782 | 0.2996243 | −0.00782 | 0.0049981 | −0.093319 |
| C | 0.2763091 | −0.154566 | 0.1635329 | −0.154566 | 0.3531215 | 0.1416254 |
| D | −0.239358 | 0.3416499 | −0.823191 | 0.3416499 | −0.519927 | 0.1471917 |
| E | 0.0782505 | −0.331173 | 0.6670421 | −0.331173 | 0.3548887 | 0.1339349 |
| F | 0.1286909 | 0.020975 | −0.71871 | 0.020975 | 0.1946845 | −0.387356 |
| G | −0.204236 | 2.69E−09 | −2.83E−07 | 2.69E−09 | 0.1440297 | 0.2628043 |

TABLE 3-3-2

| | Numbered surface | | | |
|---|---|---|---|---|
| | L₅ₒ | L₅ᵢ | L₆ₒ | L₆ᵢ |
| K | −16.91132 | −7.037279 | −0.273635 | −32951.91 |
| A | −0.195216 | −0.14831 | −0.104358 | −0.096956 |
| B | 0.0789743 | 0.1313335 | 0.0351653 | 0.0340921 |
| C | −0.007882 | −0.098632 | 0.0186416 | −0.008377 |
| D | 0.1315148 | 0.0752048 | −0.015745 | 0.0010368 |
| E | −0.191226 | −0.025525 | −0.003201 | −0.000259 |
| F | 0.8238655 | −0.006899 | 0.004528 | 6.16E−05 |
| G | −1.021081 | 0.0017734 | −0.001074 | −5.50E−06 |

### Embodiment 4

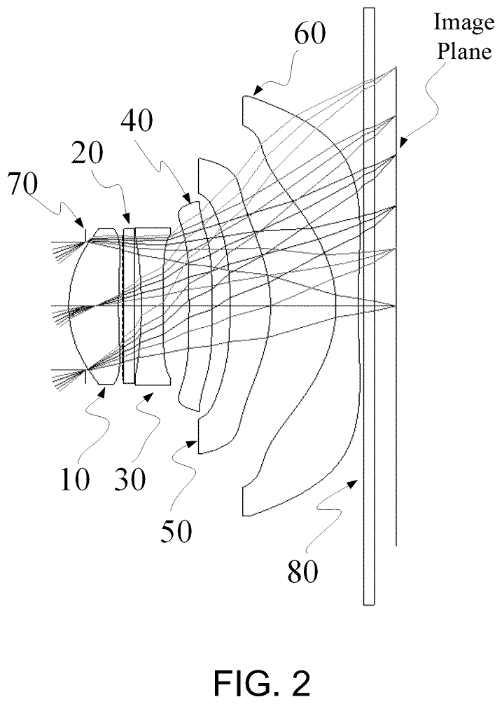

In one embodiment, embodiment 4 provides an optical system, and the optical system is shown in FIG. 2. The optical system in order from an object side to an image side, the six optical elements include: an aperture slot (STO) 70, a first lens 10, a second lens 20, a third lens 30, a fourth lens 40, a fifth lens 50 and a sixth lens 60. As shown in FIG. 2, the infrared filter is set between the sixth lens 60 and the image plane of the optical system. The optical system satisfies conditions (1-1)-(1-4):

$$f / EPD < 3 ; \qquad ( 1 - 1 )$$

$$25 ° \leq HFOV \leq 55 ° ; \qquad ( 1 - 2 )$$

$$0.05 mm \leq {d}_{2} \leq 2 mm ; \qquad ( 1 - 3 )$$

$$\vert {f}_{2} \vert / f \geq 10 ; \qquad ( 1 - 4 )$$

f is a focal length of the optical system; EPD is an entrance pupil diameter of the optical system; HFOV is a half of the maximum field of view; d₂ is a thickness of the second lens; f₂ is a focal length of the second lens.

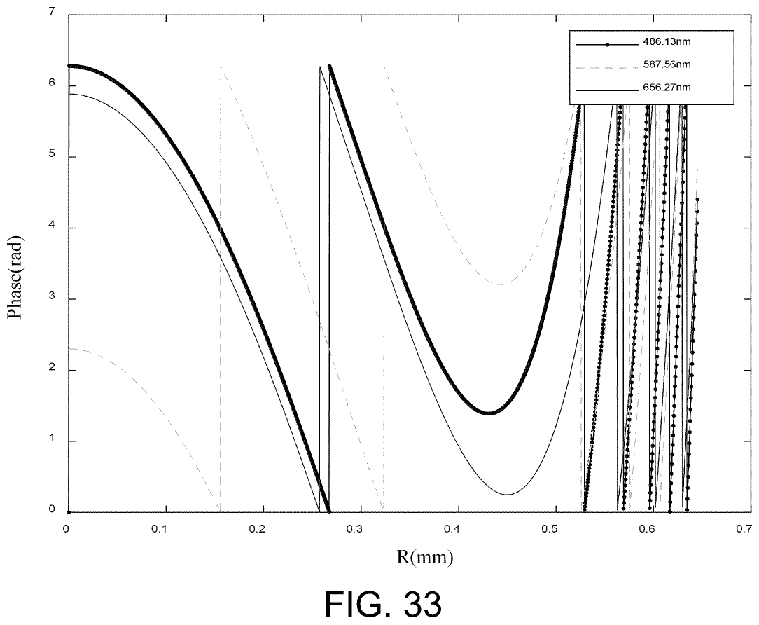

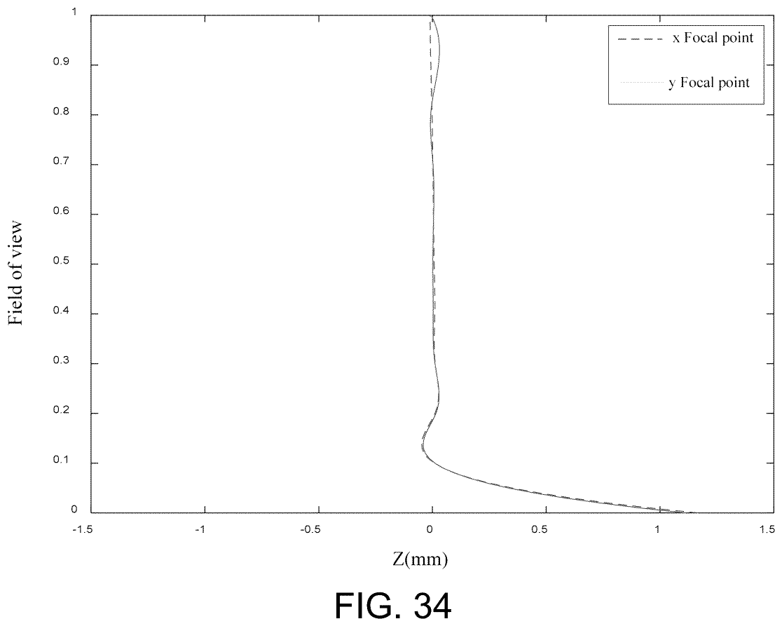

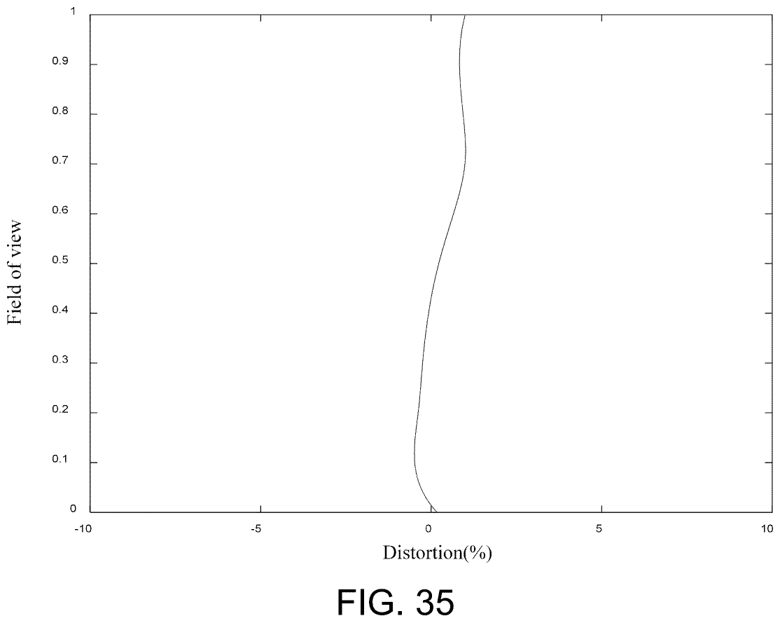

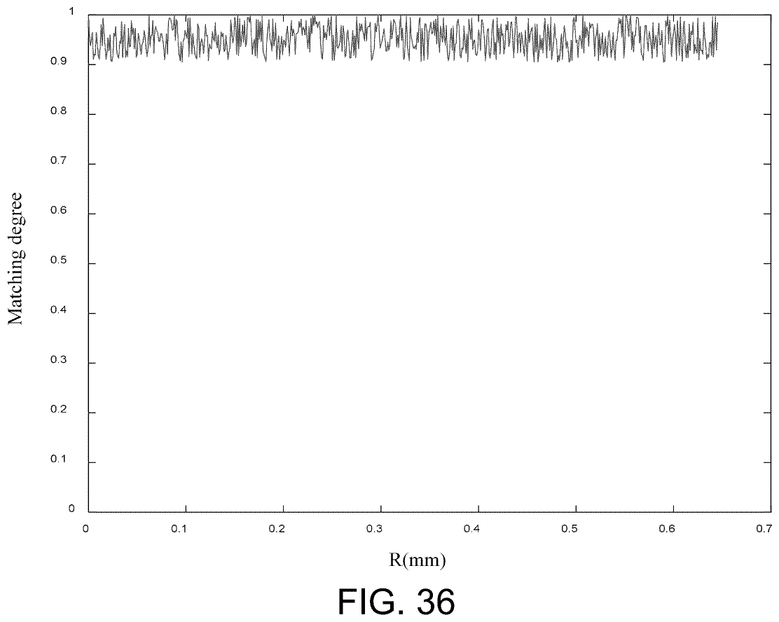

The specific parameters of the optical system provided by embodiment 4 are shown in Table 4-1. The curvature, thickness, refractive index, and other parameter items of each lens in the optical system are shown in Table 4-2. The aspherical coefficients of each surface of each lens in the optical system are shown in Table 4-3-1 and Table 4-3-2. FIG. 33 shows a phase modulation diagram of the metalens in the optical system provided by embodiment 4 at the wavelength of 486.13 nm, 587.56 nm, and 656.27 nm. It can be seen in FIG. 29 that the phases cover 0-2π of the metalens at different wavelengths. FIG. 34 shows an astigmatism diagram of the optical system. According to FIG. 34, the astigmatism of the optical system t different fields of view from 0 to 1 is less than 1 mm. FIG. 35 shows a distortion diagram of the optical system. According to FIG. 36, the distortion of the optical system at different fields of view from 0 to 1 is less than 5%. FIG. 36 shows the matching degree of the wide spectrum of the metalens in the optical system in embodiment 4. According to FIG. 36, the real phase of embodiment 4 and the theoretical phase is greater than 90%. The optical system in embodiment 4 has a high MTF and has good control of astigmatism and distortion, therefore the optical system has good imaging quality.

TABLE 4-1

| Parameter item | Value | |
|---|---|---|
| Working wavelength(WL) | VIS(400-700 nm | |
| Effective focal length(EFL) | 4.35 | mm |
| Field of view(2ω) | 66.4° | |
| F number | 2.8 | |
| Image height(ImgH) | 2.86 | mm |
| Total track length(TTL) | 4.5 | mm |

TABLE 4-2

| Numbered | | Radi- | Thick- | |
|---|---|---|---|---|
| surface | Surface type | us (mm) | ness (mm) | Material |
| L₁ₒ | Aspheric surface | Infinite | −0.179 | |
| L₁ᵢ | Aspheric surface | 1.4617 | 0.448 | 540000.560000 |
| STO | Spherical surface | −57.542 | 0.05 | |
| L₂ₒ | Structural surface | Infinite | 0.1 | 458000.676000 |
| | (metalens) | | | |
| L₂ᵢ | Spherical surface | Infinite | 0.05 | |
| L₃ₒ | Aspheric surface | −310.533 | 0.517 | 650000.214000 |
| L₃ᵢ | Aspheric surface | 3.343 | 0.392 | |
| L₄ₒ | Aspheric surface | −65.678 | 0.247 | 544000.559000 |
| L₄ᵢ | Aspheric surface | 2110.16 | 0.271 | |
| L₅ₒ | Aspheric surface | −4.071 | 0.3297 | 544000.559000 |
| L₅ᵢ | Aspheric surface | −1.911 | 0.9707 | |
| L₆ₒ | Aspheric surface | −1.3142 | 0.5916 | 544000.559000 |
| L₆ᵢ | Aspheric surface | 48.952 | 0.1317 | |
| IR filterₒ | Spherical surface | Infinite | 0.2 | 517000.642000 |
| IR filterᵢ | Spherical surface | Infinite | 0.2 | |
| Image plane | Spherical surface | Infinite | 0 | |

TABLE 4-3-1

| Numbered surface | L₁ₒ | L₁ᵢ | L₃ₒ | L₃ᵢ | L₄ₒ | L₄ᵢ |
|---|---|---|---|---|---|---|
| K | −5.966288 | −2.42E+12 | −3391307 | 8.9055836 | −2.71E+11 | 3579845.4 |
| A | 0.2329433 | 0.0225779 | 0.0443395 | 0.0226629 | −0.170495 | −0.180514 |
| B | −0.190949 | 0.084131 | −0.020353 | 0.0068781 | −0.165075 | −0.179473 |
| C | 0.2424773 | −0.244019 | 0.3302705 | 0.1209795 | 0.3803641 | 0.1265254 |
| D | −0.243905 | 0.3094722 | −0.910611 | −0.309296 | −0.451703 | −0.092659 |
| E | 0.222551 | −0.007697 | 1.2541605 | 0.4405919 | 0.1609811 | −0.024171 |
| F | −0.073802 | −0.257869 | −0.789407 | −0.215005 | −0.032096 | −0.014726 |
| G | −0.014898 | 0.0995529 | 0.099149 | −0.022872 | 0.0635873 | 0.0137494 |

TABLE 4-3-2

| | Numbered surface | | | |
|---|---|---|---|---|
| | L₅ₒ | L₅ᵢ | L₆ₒ | L₆ᵢ |
| K | 7.393398 | −9.831377 | −1.170412 | −1.08E+13 |
| A | −0.035292 | −0.126365 | −0.028974 | −0.070661 |
| B | −0.02804 | 0.1243273 | −0.026741 | 0.0042895 |
| C | −0.259869 | −0.111802 | 0.017541 | −0.005223 |
| D | 0.2856444 | 0.0678893 | −1.33E−06 | 0.0018629 |
| E | −0.171787 | −0.018036 | −0.000505 | −0.000157 |
| F | 0.0236541 | 0.0012701 | −0.000117 | 7.58E−06 |
| G | −0.024701 | 6.25E−05 | 2.49E−05 | −4.66E−06 |

### Embodiment 5

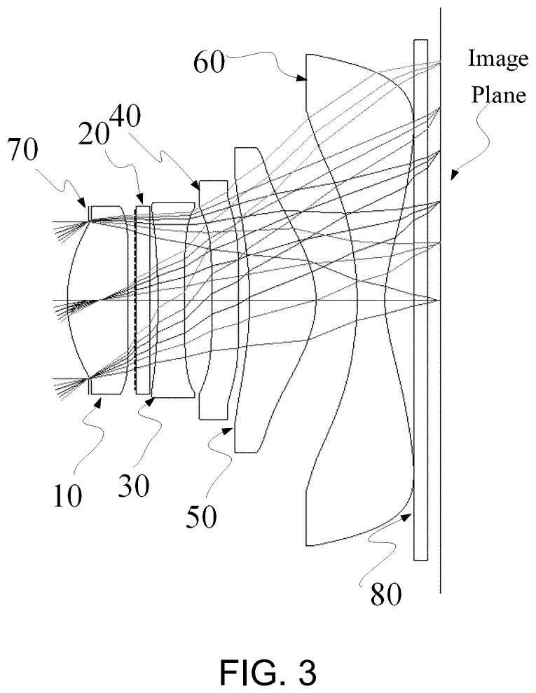

In one embodiment, embodiment 5 provides an optical system, and the optical system is shown in FIG. 3. The optical system in order from an object side to an image side, the six optical elements include: an aperture slot (STO) 70, a first lens 10, a second lens 20, a third lens 30, a fourth lens 40, a fifth lens 50 and a sixth lens 60. As shown in FIG. 3, the infrared filter is set between the sixth lens 60 and the image plane of the optical system. The optical system satisfies conditions (1-1)-(1-4):

$$f / EPD < 3 ; \qquad ( 1 - 1 )$$

$$25 ° \leq HFOV \leq 55 ° ; \qquad ( 1 - 2 )$$

$$0.05 mm \leq {d}_{2} \leq 2 mm ; \qquad ( 1 - 3 )$$

$$\vert {f}_{2} \vert / f \geq 10 ; \qquad ( 1 - 4 )$$

f is a focal length of the optical system; EPD is an entrance pupil diameter of the optical system; HFOV is a half of the maximum field of view; d₂ is a thickness of the second lens; f₂ is a focal length of the second lens.

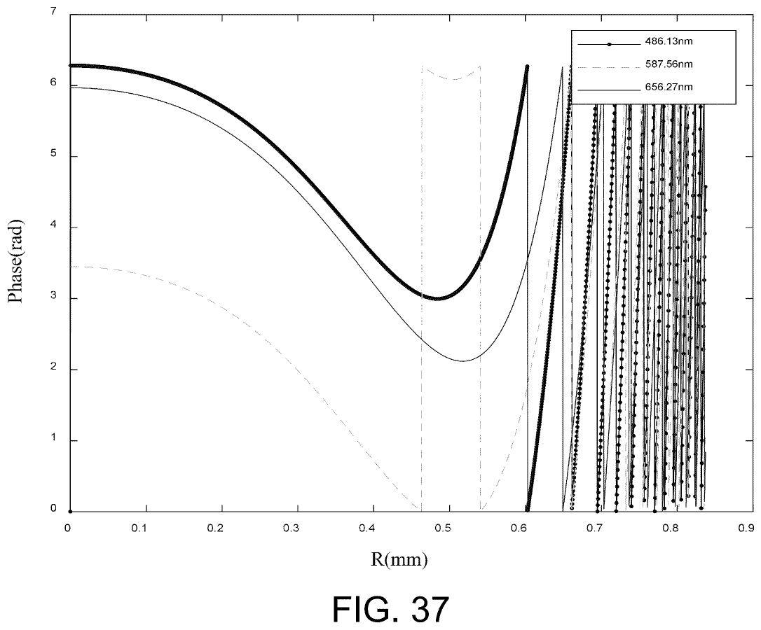

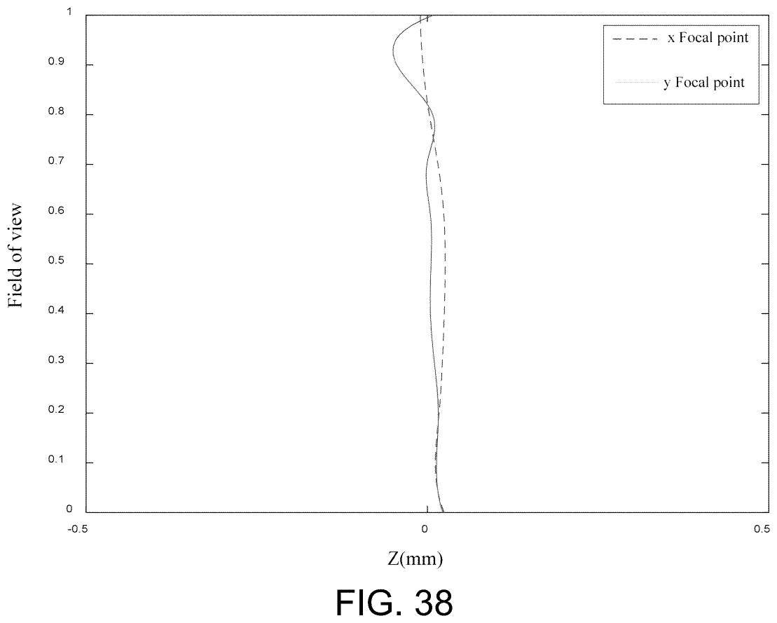

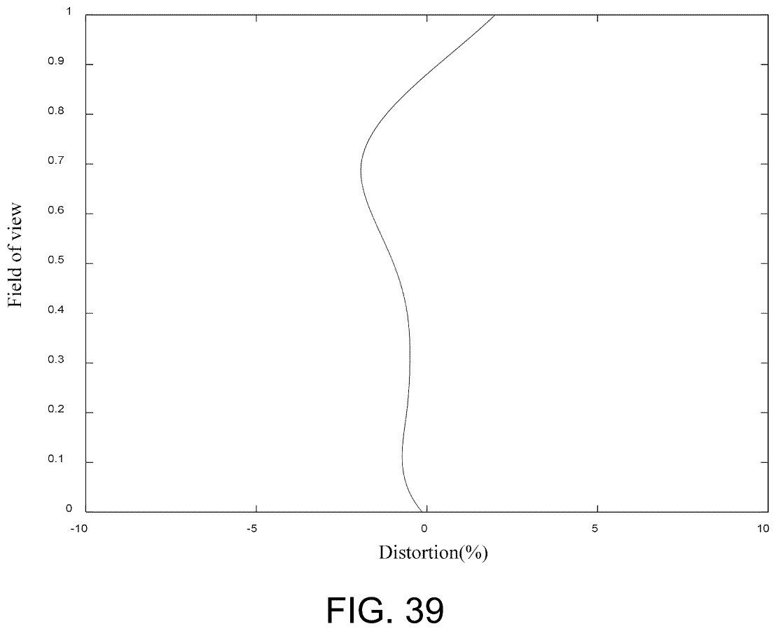

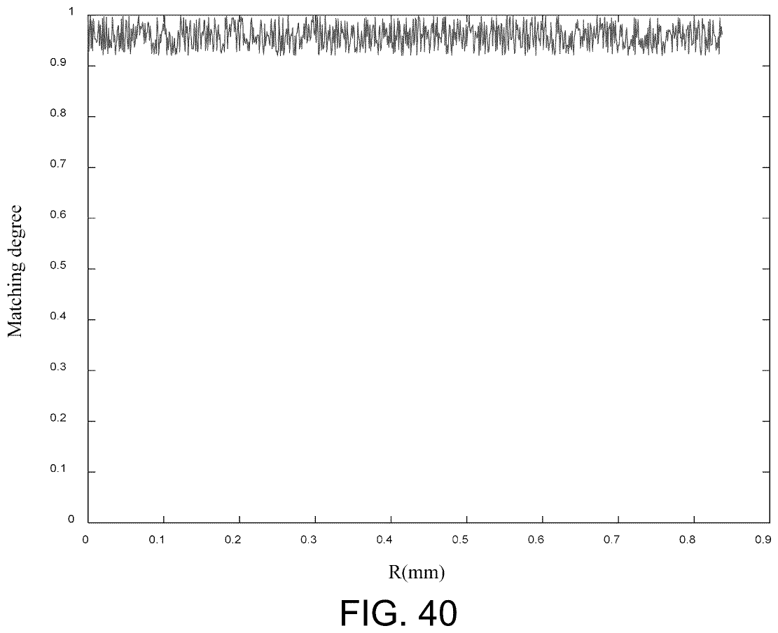

The specific parameters of the optical system provided by embodiment 5 are shown in Table 5-1. The curvature, thickness, refractive index, and other parameter items of each lens in the optical system are shown in Table 5-2. The aspherical coefficients of each surface of each lens in the optical system are shown in Table 5-3-1 and Table 5-3-2. FIG. 37 shows a phase modulation diagram of the metalens in the optical system provided by embodiment 4 at the wavelength of 486.13 nm, 587.56 nm, and 656.27 nm. It can be seen in FIG. 37 that the phases cover 0-2π of the metalens at different wavelengths. FIG. 38 shows an astigmatism diagram of the optical system. According to FIG. 38, the astigmatism of the optical system at different fields of view from 0 to 1 is less than 0.5 mm. FIG. 39 shows a distortion diagram of the optical system. According to FIG. 39, the distortion of the optical system at the different fields of view from 0 to 1 is less than 5%. FIG. 40 shows the matching degree of the wide spectrum of the metalens in the optical system in embodiment 5. According to FIG. 40, the real phase of embodiment 5 and the theoretical phase is greater than 90%. The optical system in embodiment 5 has a high MTF and has good control of astigmatism and distortion, therefore the optical system has good imaging quality.

TABLE 5-1

| Parameter item | Value | |
|---|---|---|
| Working wavelength (WL) | VIS(400-700 nm | |
| Effective focal length (EFL) | 4.35 | mm |
| Field of view (2ω) | 66.4° | |
| F number | 2.8 | |
| Image height (ImgH) | 2.86 | mm |
| Total track length (TTL) | 4.5 | mm |

TABLE 5-2

| Numbered | | Radi- | Thick- | |
|---|---|---|---|---|
| surface | Surface type | us(mm) | ness(mm) | Material |
| L₁ₒ | Aspheric surface | Infinite | −0.179 | |
| L₁ᵢ | Aspheric surface | 1.4617 | 0.448 | 540000.560000 |
| STO | Spherical surface | −57.542 | 0.05 | |
| L₂ₒ | Structural surface | Infinite | 0.1 | 458000.676000 |
| | (metalens) | | | |
| L₂ᵢ | Spherical surface | Infinite | 0.05 | |
| L₃ₒ | Aspheric surface | −310.533 | 0.517 | 650000.214000 |
| L₃ᵢ | Aspheric surface | 3.343 | 0.392 | |
| L₄ₒ | Aspheric surface | −65.678 | 0.247 | 544000.559000 |
| L₄ᵢ | Aspheric surface | 2110.16 | 0.271 | |
| L₅ₒ | Aspheric surface | −4.071 | 0.3297 | 544000.559000 |
| L₅ᵢ | Aspheric surface | −1.911 | 0.9707 | |
| L₆ₒ | Aspheric surface | −1.3142 | 0.5916 | 544000.559000 |
| L₆ᵢ | Aspheric surface | 48.952 | 0.1317 | |
| IR filterₒ | Spherical surface | Infinite | 0.2 | 517000.642000 |
| IR filterᵢ | Spherical surface | Infinite | 0.2 | |
| Image plane | Spherical surface | Infinite | 0 | |

TABLE 5-3-1

| Numbered surface | L₁ₒ | L₁ᵢ | L₃ₒ | L₃ᵢ | L₄ₒ | L₄ᵢ |
|---|---|---|---|---|---|---|
| K | −5.966288 | −2.42E+12 | −3391307 | 8.9055836 | −2.71E+11 | 3579845.4 |
| A | 0.2329433 | 0.0225779 | 0.0443395 | 0.0226629 | −0.170495 | −0.180514 |
| B | −0.190949 | 0.084131 | −0.020353 | 0.0068781 | −0.165075 | −0.179473 |
| C | 0.2424773 | −0.244019 | 0.3302705 | 0.1209795 | 0.3803641 | 0.1265254 |
| D | −0.243905 | 0.3094722 | −0.910611 | −0.309296 | −0.451703 | −0.092659 |
| E | 0.222551 | −0.007697 | 1.2541605 | 0.4405919 | 0.1609811 | −0.024171 |
| F | −0.073802 | −0.257869 | −0.789407 | −0.215005 | −0.032096 | −0.014726 |
| G | −0.014898 | 0.0995529 | 0.099149 | −0.022872 | 0.0635873 | 0.0137494 |

TABLE 5-3-2

| | Numbered surface | | | |
|---|---|---|---|---|
| | L₅ₒ | L₅ᵢ | L₆ₒ | L₆ᵢ |
| K | 7.393398 | −9.831377 | −1.170412 | −1.08E+13 |
| A | −0.035292 | −0.126365 | −0.028974 | −0.070661 |
| B | −0.02804 | 0.1243273 | −0.026741 | 0.0042895 |
| C | −0.259869 | −0.111802 | 0.017541 | −0.005223 |
| D | 0.2856444 | 0.0678893 | −1.33E−06 | 0.0018629 |
| E | −0.171787 | −0.018036 | −0.000505 | −0.000157 |
| F | 0.0236541 | 0.0012701 | −0.000117 | 7.58E−06 |
| G | −0.024701 | 6.25E−05 | 2.49E−05 | −4.66E−06 |

### Embodiment 6

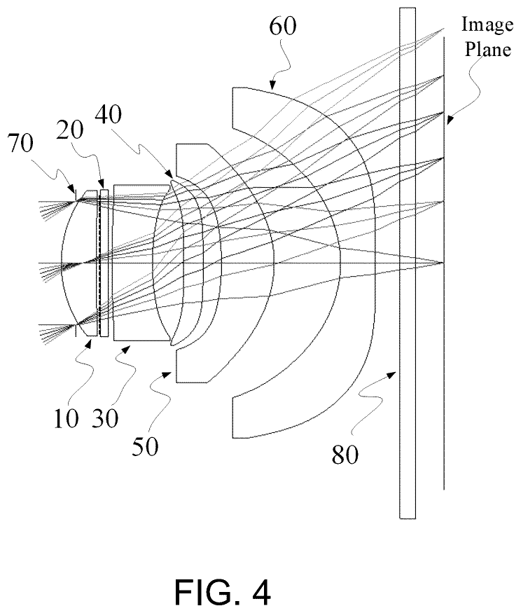

In one embodiment, embodiment 6 provides an optical system, and the optical system is shown in FIG. 4. The optical system in order from an object side to an image side, the six optical elements include: an aperture slot (STO) 70, a first lens 10, a second lens 20, a third lens 30, a fourth lens 40, a fifth lens 50 and a sixth lens 60. As shown in FIG. 4, the infrared filter is set between the sixth lens 60 and the image plane of the optical system. The optical system satisfies conditions (1-1)-(1-4):

$$f / EPD < 3 ; \qquad ( 1 - 1 )$$

$$25 ° \leq HFOV \leq 55 ° ; \qquad ( 1 - 2 )$$

$$0.05 mm \leq {d}_{2} \leq 2 mm ; \qquad ( 1 - 3 )$$

$$\vert {f}_{2} \vert / f \geq 10 ; \qquad ( 1 - 4 )$$

f is a focal length of the optical system; EPD is an entrance pupil diameter of the optical system; HFOV is a half of the maximum field of view; d₂ is a thickness of the second lens; f₂ is a focal length of the second lens.

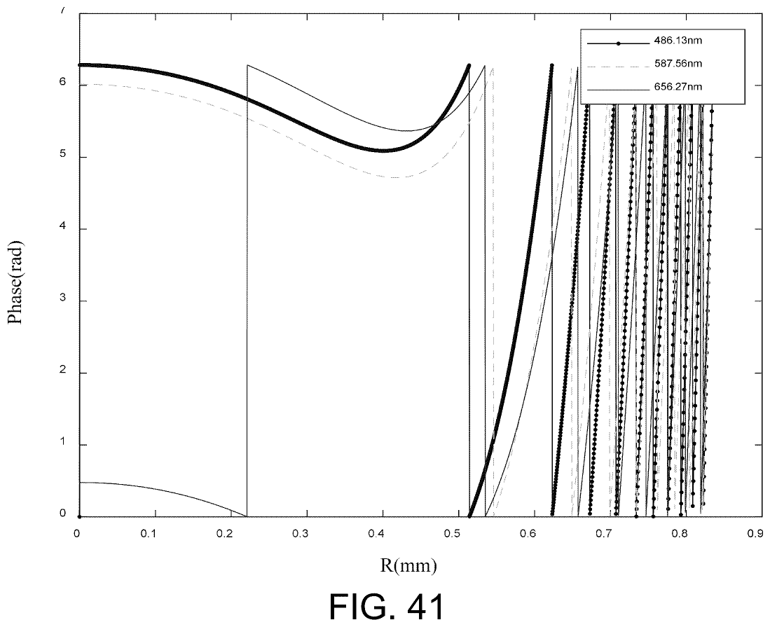

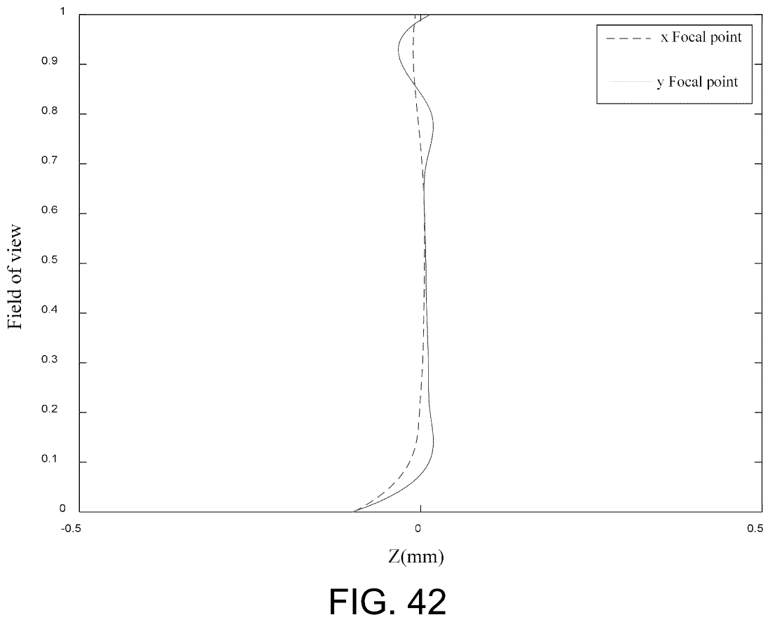

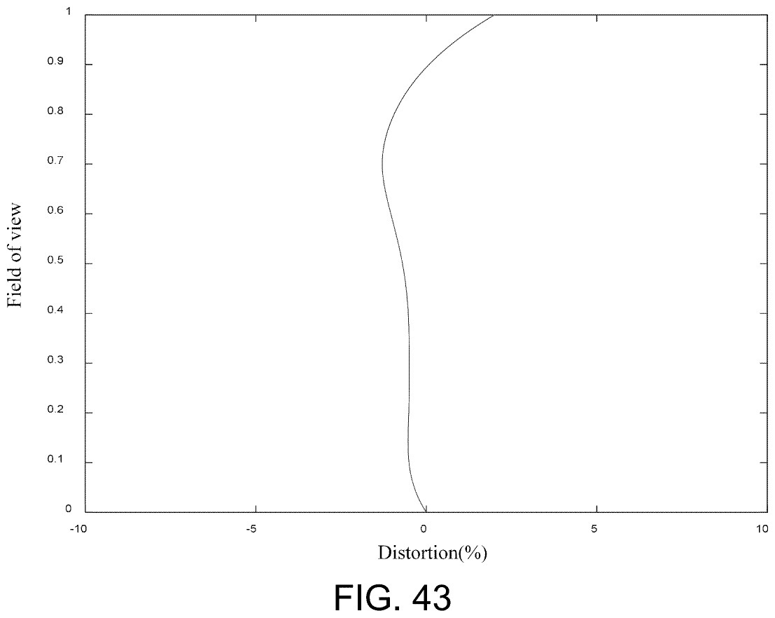

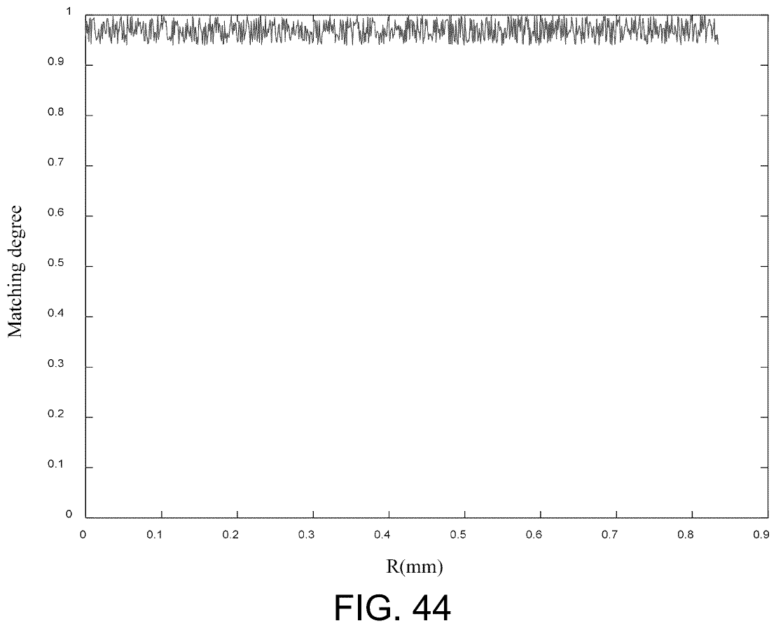

The specific parameters of the optical system provided by embodiment 6 are shown in Table 6-1. The curvature, thickness, refractive index, and other parameter items of each lens in the optical system are shown in Table 6-2. The aspherical coefficients of each surface of each lens in the optical system are shown in Table 6-3-1 and Table 6-3-2. FIG. 41 shows a phase modulation diagram of the metalens in the optical system provided by embodiment 6 at the wavelength of 486.13 nm, 587.56 nm, and 656.27 nm. It can be seen in FIG. 41 that the phases cover 0-2π of the metalens at different wavelengths. FIG. 42 shows an astigmatism diagram of the optical system. According to FIG. 42, the astigmatism of the optical system at different fields of view from 0 to 1 is less than 0.5 mm. FIG. 43 shows a distortion diagram of the optical system. According to FIG. 43, the distortion of the optical system at the different fields of view from 0 to 1 is less than 5%. FIG. 44 shows the matching degree of the wide spectrum of the metalens in the optical system in embodiment 6. According to FIG. 44, the real phase of embodiment 6 and the theoretical phase is greater than 90%. The optical system in embodiment 6 has a high MTF and has good control of astigmatism and distortion, therefore the optical system has good imaging quality.

TABLE 6-1

| Parameter item | Value | |
|---|---|---|
| Working wavelength(WL) | VIS(400-700 nm) | |
| Effective focal length(EFL) | 4.35 | mm |
| Field of view(2ω) | 66.4° | |
| F number | 2.8 | |
| Image height(ImgH) | 2.86 | mm |
| Total track length(TTL) | 4.8 | mm |

TABLE 6-2

| Numbered | | Radi- | Thick- | |
|---|---|---|---|---|
| surface | Surface type | us(mm) | ness(mm) | Material |
| L₁ₒ | Aspheric surface | Infinite | −0.179 | |
| L₁ᵢ | Aspheric surface | 1.502 | 0.4439 | 540000.560000 |
| STO | Spherical surface | −57.746 | 0.05 | |
| L₂ₒ | Structural surface | Infinite | 0.1 | 458000.676000 |
| | (metalens) | | | |
| L₂ᵢ | Spherical surface | Infinite | 0.05 | |
| L₃ₒ | Aspheric surface | −162.64 | 0.5014 | 650000.214000 |
| L₃ᵢ | Aspheric surface | 3.28 | 0.3897 | |
| L₄ₒ | Aspheric surface | −75.68 | 0.2437 | 544000.559000 |
| L₄ᵢ | Aspheric surface | −3528.37 | 0.2305 | |
| L₅ₒ | Aspheric surface | −3.032 | 0.6624 | 544000.559000 |
| L₅ᵢ | Aspheric surface | −1.385 | 0.833 | |
| L₆ₒ | Aspheric surface | −1.441 | 0.437 | 544000.559000 |
| L₆ᵢ | Aspheric surface | 103.45 | 0.309 | |
| IR filterₒ | Spherical surface | Infinite | 0.2 | 517000.642000 |
| IR filterᵢ | Spherical surface | Infinite | 0.351 | |
| Image plane | Spherical surface | Infinite | 0 | |

TABLE 6-3-1

| Numbered surface | L₁ₒ | L₁ᵢ | L₃ₒ | L₃ᵢ | L₄ₒ | L₄ᵢ |
|---|---|---|---|---|---|---|
| K | −6.298823 | −1.44E+09 | 4494.0281 | 9.0173416 | −2.71E+11 | 3579844.8 |
| A | 0.2328819 | 0.0163406 | 0.0434831 | 0.023808 | −0.159046 | −0.153343 |
| B | −0.189128 | 0.0819098 | −0.033197 | 0.0108811 | −0.163954 | −0.174469 |
| C | 0.243266 | −0.248175 | 0.3162488 | 0.1188544 | 0.3959701 | 0.129007 |
| D | −0.245024 | 0.3073064 | −0.917541 | −0.317968 | −0.428012 | −0.080051 |
| E | 0.2196216 | −0.009503 | 1.2517769 | 0.4367565 | 0.1817307 | −0.012739 |
| F | −0.078589 | −0.262487 | −0.791435 | −0.224711 | −0.024716 | −0.012186 |
| G | −0.021959 | 0.0914779 | 0.0865926 | −0.022393 | 0.042974 | 0.0046107 |

TABLE 6-3-2

| | Numbered surface | | | |
|---|---|---|---|---|
| | L₅ₒ | L₅ᵢ | L₆ₒ | L₆ᵢ |
| K | 5.449457 | −4.418018 | −1.591146 | −923370.9 |
| A | −0.023181 | −0.146235 | −0.020388 | −0.062532 |
| B | −0.014869 | 0.1181804 | −0.029459 | 0.0096317 |
| C | −0.242987 | −0.114044 | 0.0116144 | −0.005348 |
| D | 0.2913974 | 0.0673508 | −0.001066 | 0.0016265 |
| E | −0.172454 | −0.01805 | −0.000278 | −0.000196 |
| F | 0.0284623 | 0.0013237 | −7.08E−06 | 6.84E−06 |
| G | −0.008201 | 7.92E−05 | −1.21E−05 | −1.75E−06 |

### Embodiment 7

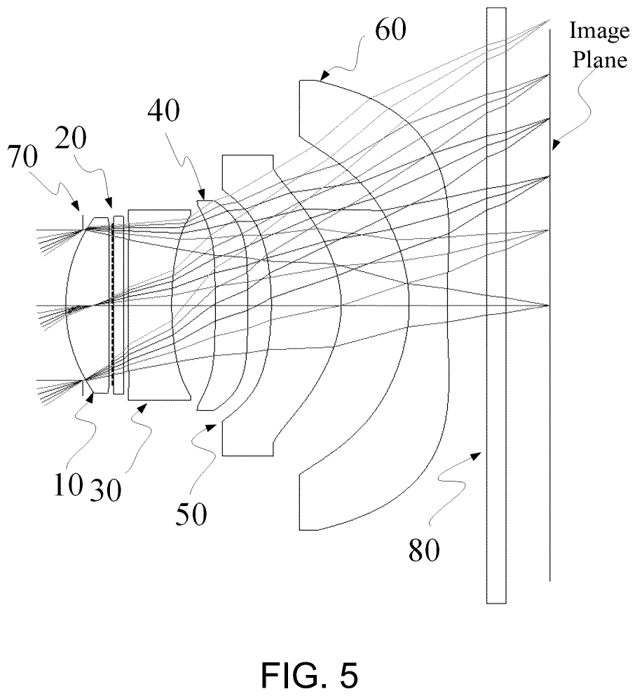

In one embodiment, embodiment 7 provides an optical system, and the optical system is shown in FIG. 5. The optical system in order from an object side to an image side, the six optical elements include: an aperture slot (STO) 70, a first lens 10, a second lens 20, a third lens 30, a fourth lens 40, a fifth lens 50 and a sixth lens 60. As shown in FIG. 5, the infrared filter is set between the sixth lens 60 and the image plane of the optical system. The optical system satisfies conditions (1-1)-(1-4):

$$f / EPD < 3 ; \qquad ( 1 - 1 )$$

$$25 ° \leq HFOV \leq 55 ° ; \qquad ( 1 - 2 )$$

$$0.05 mm \leq {d}_{2} \leq 2 mm ; \qquad ( 1 - 3 )$$

$$\vert {f}_{2} \vert / f \geq 10 ; \qquad ( 1 - 4 )$$

f is a focal length of the optical system; EPD is an entrance pupil diameter of the optical system; HFOV is a half of the maximum field of view; d₂ is a thickness of the second lens; f₂ is a focal length of the second lens.

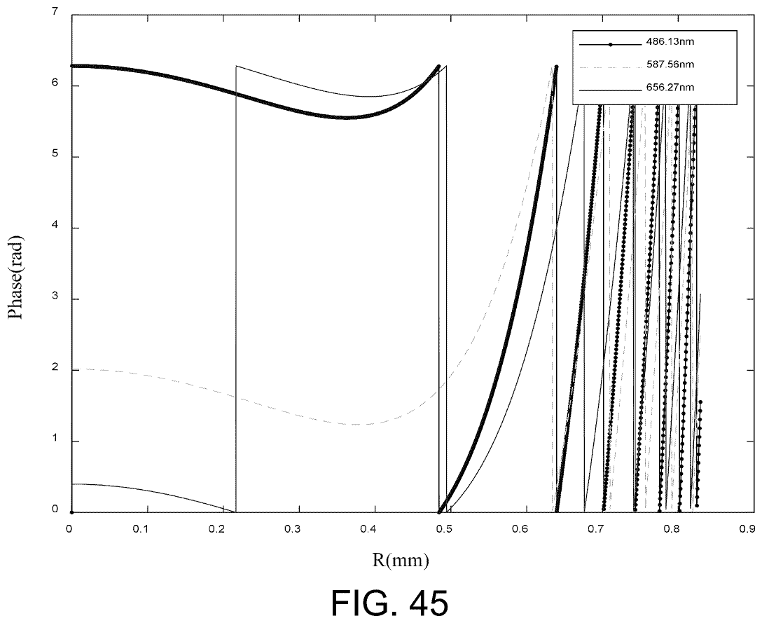

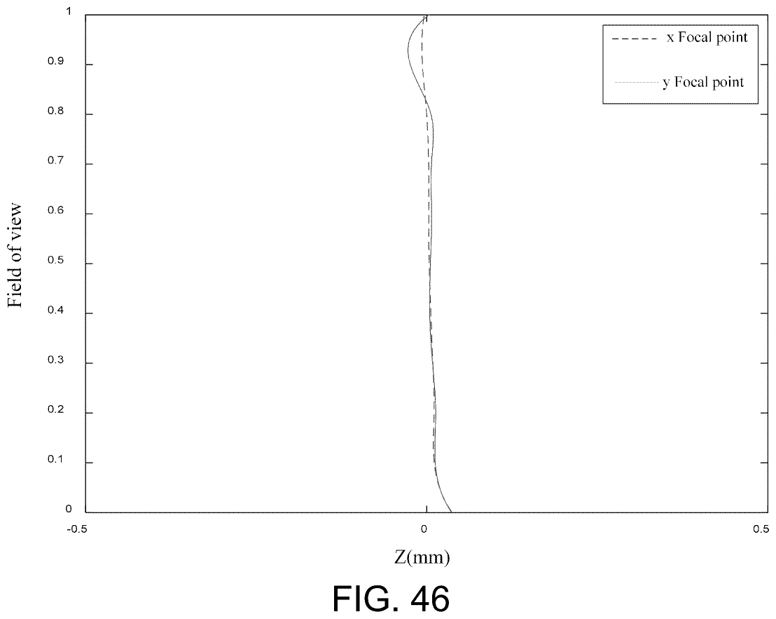

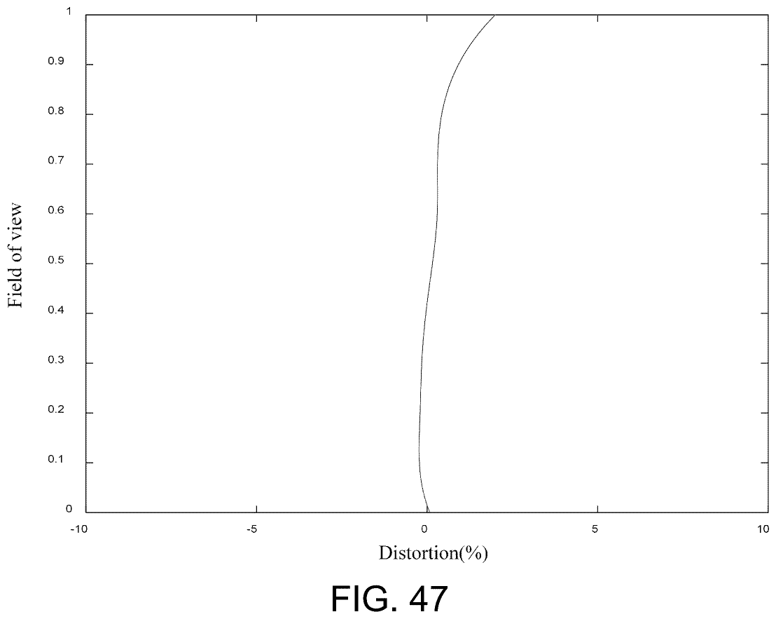

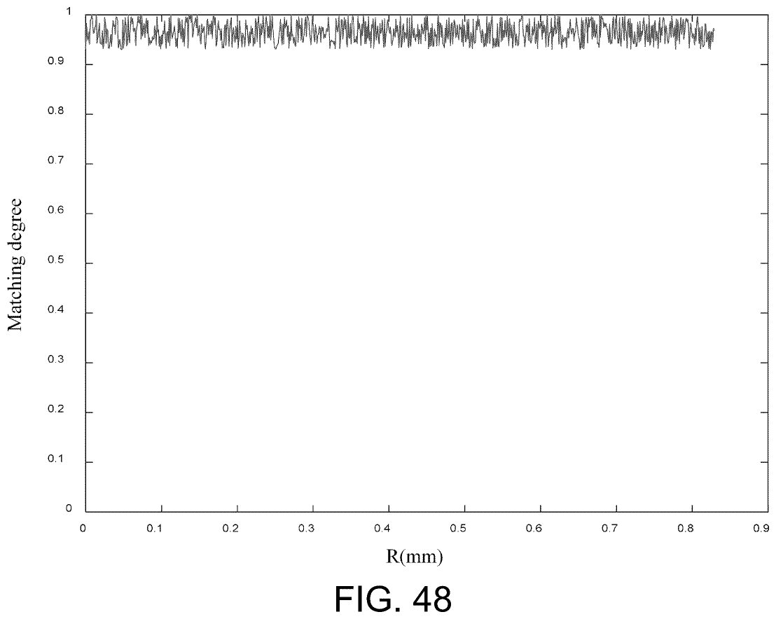

The specific parameters of the optical system provided by embodiment 7 are shown in Table 7-1. The curvature, thickness, refractive index, and other parameter items of each lens in the optical system are shown in Table 7-2. The aspherical coefficients of each surface of each lens in the optical system are shown in Table 7-3-1 and Table 7-3-2. FIG. 45 shows a phase modulation diagram of the metalens in the optical system provided by embodiment 7 at the wavelength of 486.13 nm, 587.56 nm, and 656.27 nm. It can be seen in FIG. 45 that the phases cover 0-2π of the metalens at different wavelengths. FIG. 46 shows an astigmatism diagram of the optical system. According to FIG. 46, the astigmatism of the optical system at different fields of view from 0 to 1 is less than 0.5 mm. FIG. 47 shows a distortion diagram of the optical system. According to FIG. 47, the distortion of the optical system at the different fields of view from 0 to 1 is less than 5%. FIG. 48 shows the matching degree of the wide spectrum of the metalens in the optical system in embodiment 7. According to FIG. 48, the real phase of embodiment 7 and the theoretical phase is greater than 90%. The optical system in embodiment 7 has a high MTF and has good control of astigmatism and distortion, therefore the optical system has good imaging quality.

TABLE 7-1

| Parameter item | Value | |
|---|---|---|
| Working wavelength(WL) | VIS(400-700 nm) | |
| Effective focal length(EFL) | 4.35 | mm |
| Field of view(2ω) | 66.4° | |
| F number | 2.8 | |
| Image height(ImgH) | 2.86 | mm |
| Total track length(TTL) | 5 | mm |

TABLE 7-2

| Numbered | | Radi- | Thick- | |
|---|---|---|---|---|
| surface | Surface type | us(mm) | ness(mm) | Material |
| L₁ₒ | Aspheric surface | Infinite | −0.179 | |
| L₁ᵢ | Aspheric surface | 1.570 | 0.445 | 540000.560000 |
| STO | Spherical surface | −66.946 | 0.05 | |
| L₂ₒ | Structural surface | Infinite | 0.1 | 458000.676000 |
| | (metalens) | | | |
| L₂ᵢ | Spherical surface | Infinite | 0.05 | |
| L₃ₒ | Aspheric surface | −68.82 | 0.4488 | 650000.214000 |
| L₃ᵢ | Aspheric surface | 3.515 | 0.448 | |
| L₄ₒ | Aspheric surface | −118.622 | 0.334 | 544000.559000 |
| L₄ᵢ | Aspheric surface | −2124.17 | 0.246 | |
| L₅ₒ | Aspheric surface | −3.002 | 0.721 | 544000.559000 |
| L₅ᵢ | Aspheric surface | −1.209 | 0.703 | |
| L₆ₒ | Aspheric surface | −1.663 | 0.393 | 544000.559000 |
| L₆ᵢ | Aspheric surface | 7.599 | 0.409 | |
| IR filterₒ | Spherical surface | Infinite | 0.2 | 517000.642000 |
| IR filterᵢ | Spherical surface | Infinite | 0.451 | |
| Image plane | Spherical surface | Infinite | 0 | |

TABLE 7-3-1

| Numbered Surface | L₁ₒ | L₁ᵢ | L₃ₒ | L₃ᵢ | L₄ₒ | L₄ᵢ |
|---|---|---|---|---|---|---|
| K | −6.866986 | −6.50E+17 | 1807.6794 | 10.166595 | −2.71E+11 | 3579844.8 |
| A | 0.2257324 | 0.0119433 | 0.0416517 | 0.0198582 | −0.138368 | −0.12256 |
| B | −0.191076 | 0.0745011 | −0.04731 | 0.0022403 | −0.157588 | −0.163894 |
| C | 0.2415081 | −0.253678 | 0.3020482 | 0.117878 | 0.3742538 | 0.1259188 |
| D | −0.250313 | 0.300814 | −0.91587 | −0.320155 | −0.441698 | −0.072029 |
| E | 0.2119385 | −0.020147 | 1.2630085 | 0.4304741 | 0.1955174 | −0.000838 |
| F | −0.087454 | −0.277049 | −0.785507 | −0.226645 | −0.003719 | −0.00446 |
| G | −0.033402 | 0.0788317 | 0.0717898 | −0.004676 | 0.0097744 | 0.0056857 |

TABLE 7-3-2

| | Numbered surface | | | |
|---|---|---|---|---|
| | L₅ₒ | L₅ᵢ | L₆ₒ | L₆ᵢ |
| K | 3.9454931 | −3.493687 | −2.872541 | −113.7933 |
| A | −0.010584 | −0.12459 | −0.003755 | −0.04692 |
| B | −0.002316 | 0.1141337 | −0.036561 | 0.0095773 |
| C | −0.229498 | −0.11463 | 0.0102034 | −0.005563 |
| D | 0.2934907 | 0.0677801 | −0.001166 | 0.0015399 |
| E | −0.170049 | −0.017807 | −0.000219 | −0.000204 |
| F | 0.0367623 | 0.0014584 | 4.37E−05 | 9.70E−06 |
| G | 0.0033356 | 0.0001445 | 1.29E−05 | −3.35E−07 |

### Embodiment 8

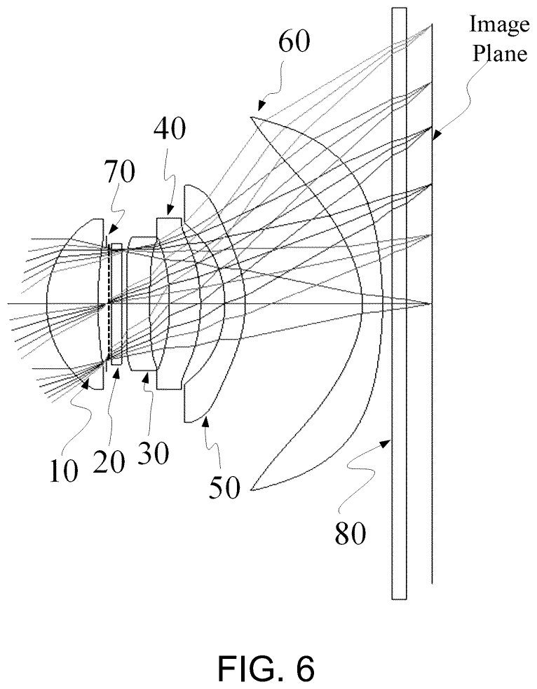

In one embodiment, embodiment 8 provides an optical system, and the optical system is shown in FIG. 6. The optical system in order from an object side to an image side, the six optical elements include: an aperture slot (STO) 70, a first lens 10, a second lens 20, a third lens 30, a fourth lens 40, a fifth lens 50 and a sixth lens 60. As shown in FIG. 6, the infrared filter is set between the sixth lens 60 and the image plane of the optical system. The optical system satisfies conditions (1-1)-(1-4):

$$f / EPD < 3 ; \qquad ( 1 - 1 )$$

$$25 ° \leq HFOV \leq 55 ° ; \qquad ( 1 - 2 )$$

$$0.05 mm \leq {d}_{2} \leq 2 mm ; \qquad ( 1 - 3 )$$

$$\vert {f}_{2} \vert / f \geq 10 ; \qquad ( 1 - 4 )$$

f is a focal length of the optical system; EPD is an entrance pupil diameter of the optical system; HFOV is a half of the maximum field of view; d₂ is a thickness of the second lens; f₂ is a focal length of the second lens.

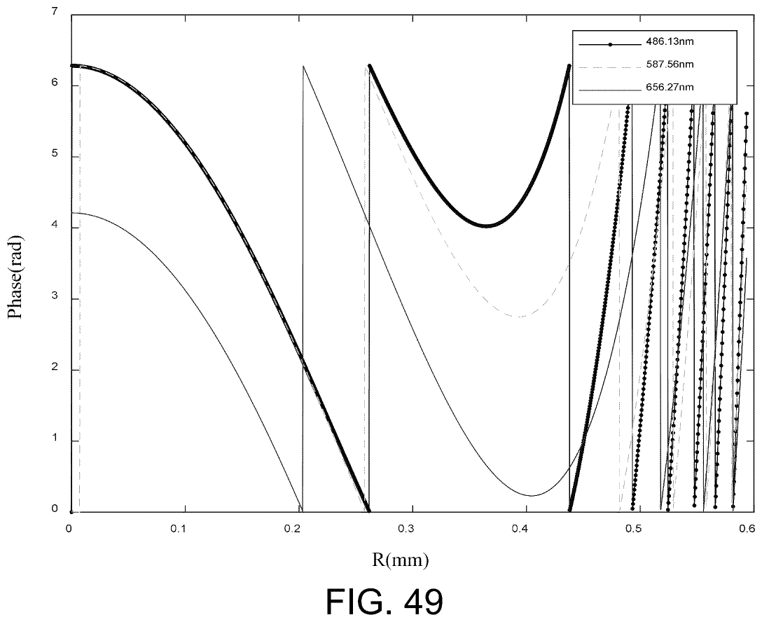

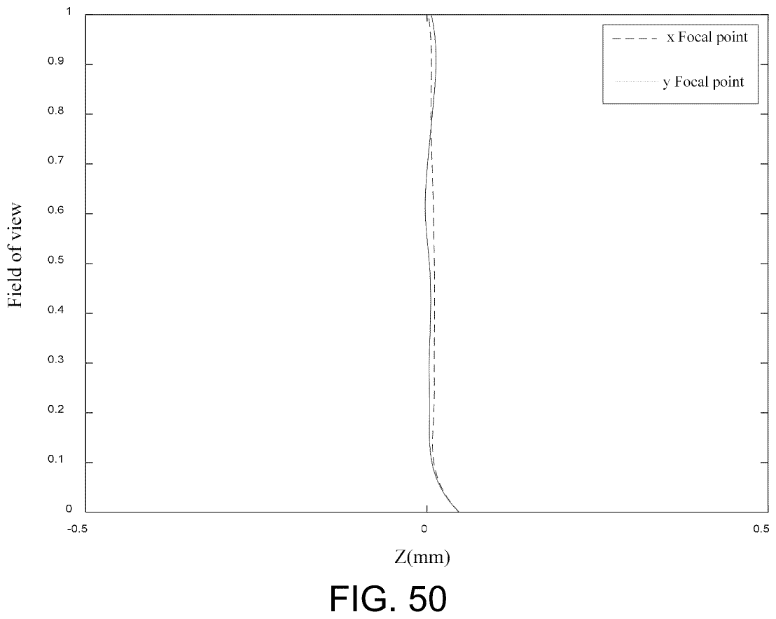

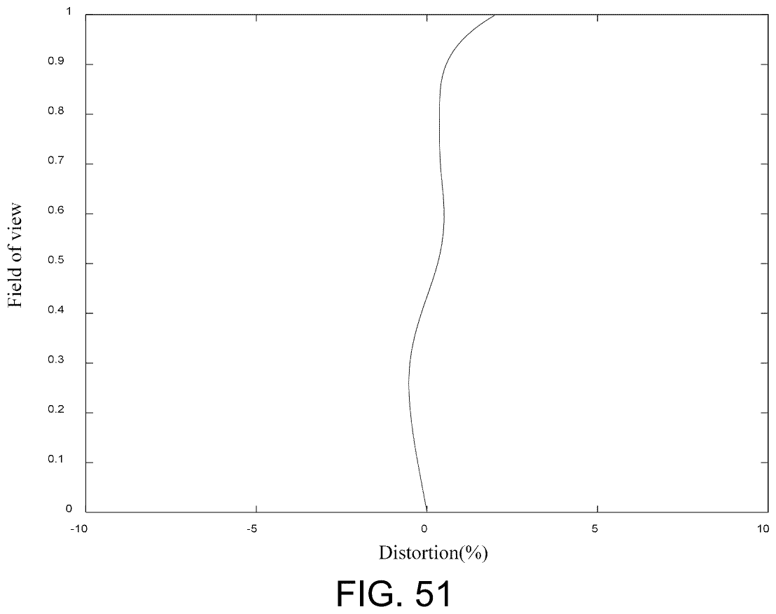

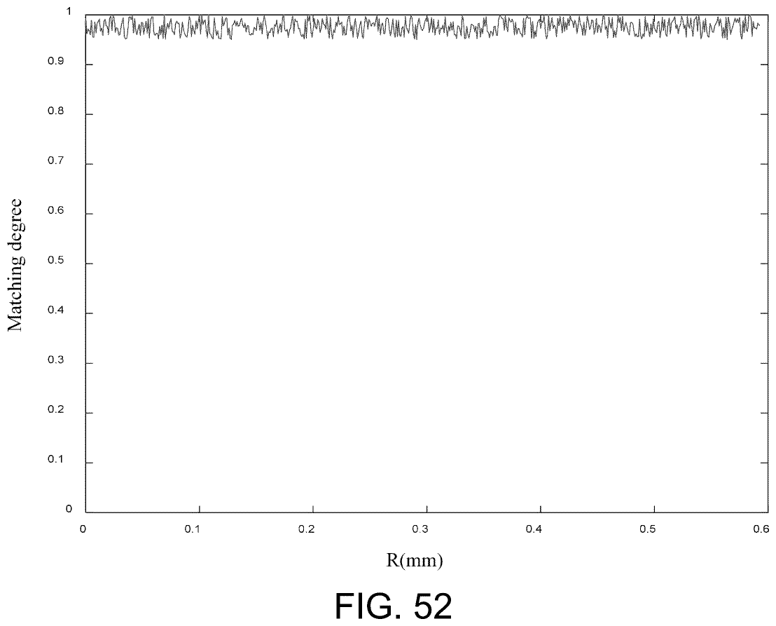

The specific parameters of the optical system provided by embodiment 8 are shown in Table 8-1. The curvature, thickness, refractive index, and other parameter items of each lens in the optical system are shown in Table 8-2. The aspherical coefficients of each surface of each lens in the optical system are shown in Table 8-3-1 and Table 8-3-2. FIG. 49 shows a phase modulation diagram of the metalens in the optical system provided by embodiment 8 at the wavelength of 486.13 nm, 587.56 nm, and 656.27 nm. It can be seen in FIG. 49 that the phases cover 0-2π of the metalens at different wavelengths. FIG. 50 shows an astigmatism diagram of the optical system. According to FIG. 50, the astigmatism of the optical system at different fields of view from 0 to 1 is less than 0.5 mm. FIG. 51 shows a distortion diagram of the optical system. According to FIG. 51, the distortion of the optical system at the different fields of view from 0 to 1 is less than 5%. FIG. 52 shows the matching degree of the wide spectrum of the metalens in the optical system in embodiment 8. According to FIG. 52, the real phase of embodiment 8 and the theoretical phase is greater than 90%. [0166] The optical system in embodiment 8 has a high MTF and has good control of astigmatism and distortion, therefore the optical system has good imaging quality.

TABLE 8-1

| Parameter item | Value | |
|---|---|---|
| Working wavelength(WL) | VIS(400-700 nm) | |
| Effective focal length(EFL) | 4 | mm |
| Field of view(2ω) | 66.4° | |
| F number | 2.85 | |
| Image height(ImgH) | 3.014 | mm |
| Total track length(TTL) | 3.8 | mm |

TABLE 8-2

| Numbered | | Radi- | Thick- | |
|---|---|---|---|---|
| surface | Surface type | us(mm) | ness(mm) | Material |
| L₁ₒ | Aspheric surface | 1.172 | 0.507 | 540000.560000 |
| L₁ᵢ | Aspheric surface | 4.349 | 0.083 | |
| STO | Spherical surface | Infinite | 0.05 | |
| L₂ₒ | Structural surface | Infinite | 0.1 | 458000.676000 |
| | (metalens) | | | |
| L₂ᵢ | Spherical surface | Infinite | 0.05 | |
| L₃ₒ | Aspheric surface | −66.92 | 0.227 | 634000.238000 |
| L₃ᵢ | Aspheric surface | 6.646 | 0.1949 | |
| L₄ₒ | Aspheric surface | −3.012 | 0.3058 | 544000.559000 |
| L₄ᵢ | Aspheric surface | −2.1876 | 0.2413 | |
| L₅ₒ | Aspheric surface | −1.2494 | 0.20 | 544000.559000 |
| L₅ᵢ | Aspheric surface | −1.4336 | 1.155 | |
| L₆ₒ | Aspheric surface | −1.1985 | 0.20 | 544000.559000 |
| L₆ᵢ | Aspheric surface | −4.4735 | 0.0952 | |
| IR filterₒ | Spherical surface | Infinite | 0.145 | 517000.642000 |
| IR filterᵢ | Spherical surface | Infinite | 0.245 | |
| Image plane | Spherical surface | Infinite | 0 | |

TABLE 8-3-1

| Numbered Surface | L₁ₒ | L₁ᵢ | L₃ₒ | L₃ᵢ | L₄ₒ | L₄ᵢ |
|---|---|---|---|---|---|---|
| K | −4.121835 | −0.301316 | −2.21E+11 | −31.00754 | −9.637143 | −4.783519 |
| A | 0.3143153 | −0.040117 | −0.01614 | −0.011515 | −0.220447 | −0.201925 |
| B | −0.235618 | 0.0631101 | 0.2904891 | 0.3269966 | 0.0417757 | 0.0195985 |
| C | 0.3037657 | −0.19679 | 0.3198971 | 0.2285097 | 0.4684934 | 0.1731913 |
| D | −0.161598 | 0.3463478 | −0.849183 | −0.46272 | −0.624094 | −0.024136 |
| E | −0.004637 | −0.07463 | 1.3493986 | 0.2231465 | 0.6794831 | 0.1113262 |
| F | −0.031613 | 0.6074249 | −0.674074 | 0.9021309 | 0.8751026 | 0.0902933 |
| G | 0.1849747 | −1.287904 | −0.013711 | −0.057478 | −4.508269 | −0.144805 |

TABLE 8-3-2

| | Numbered surface | | | |
|---|---|---|---|---|
| | L₅ₒ | L₅ᵢ | L₆ₒ | L₆ᵢ |
| K | −1.248789 | −3.676745 | −2.905965 | 0.6365684 |
| A | −0.16175 | −0.08591 | −0.000951 | 0.0036439 |
| B | 0.028044 | 0.1591998 | −0.029449 | −0.003586 |
| C | −0.159878 | −0.125683 | 0.011773 | −0.008968 |
| D | 0.2038551 | 0.0664692 | −0.000814 | 0.00332 |
| E | −0.241458 | −0.017064 | −0.000187 | −0.000162 |
| F | 0.05715 | −0.000206 | 2.10E−05 | −0.000112 |
| G | 0.1186811 | −0.002795 | −3.44E−08 | 1.25E−05 |

### Embodiment 9

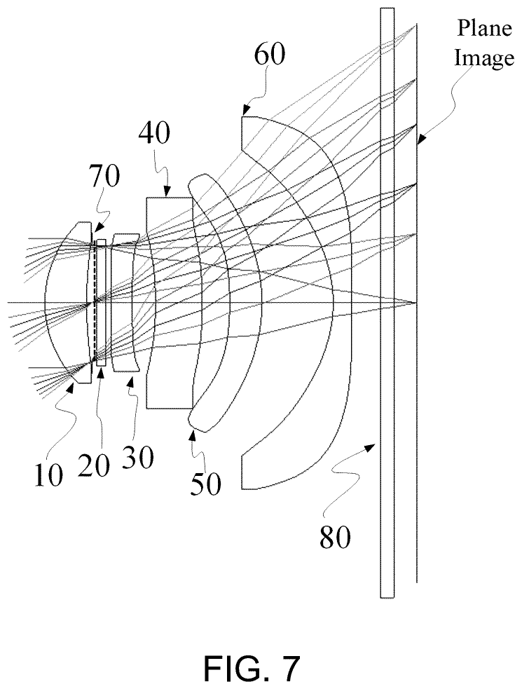

In one embodiment, embodiment 9 provides an optical system, and the optical system is shown in FIG. 7. The optical system in order from an object side to an image side, the six optical elements include: an aperture slot (STO) 70, a first lens 10, a second lens 20, a third lens 30, a fourth lens 40, a fifth lens 50 and a sixth lens 60. As shown in FIG. 7, the infrared filter is set between the sixth lens 60 and the image plane of the optical system. The optical system satisfies conditions (1-1)-(1-4):

$$f / EPD < 3 ; \qquad ( 1 - 1 )$$

$$25 ° \leq HFOV \leq 55 ° ; \qquad ( 1 - 2 )$$

$$0.05 mm \leq {d}_{2} \leq 2 mm ; \qquad ( 1 - 3 )$$

$$\vert {f}_{2} \vert / f \geq 10 ; \qquad ( 1 - 4 )$$

f is a focal length of the optical system; EPD is an entrance pupil diameter of the optical system; HFOV is a half of the maximum field of view; d₂ is a thickness of the second lens; f₂ is a focal length of the second lens.

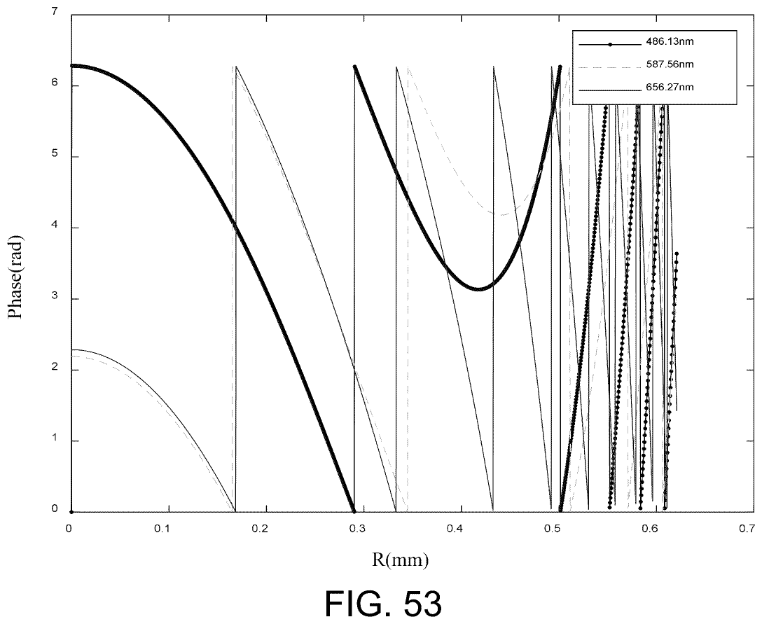

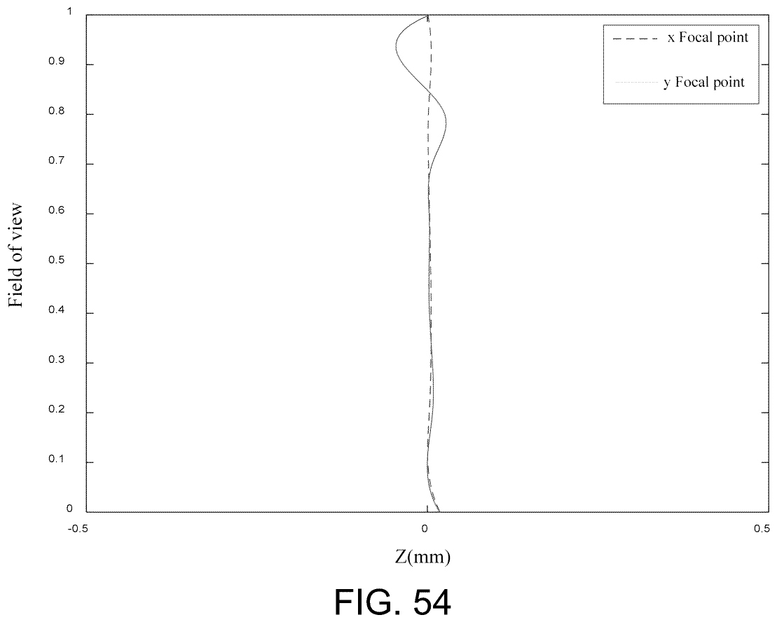

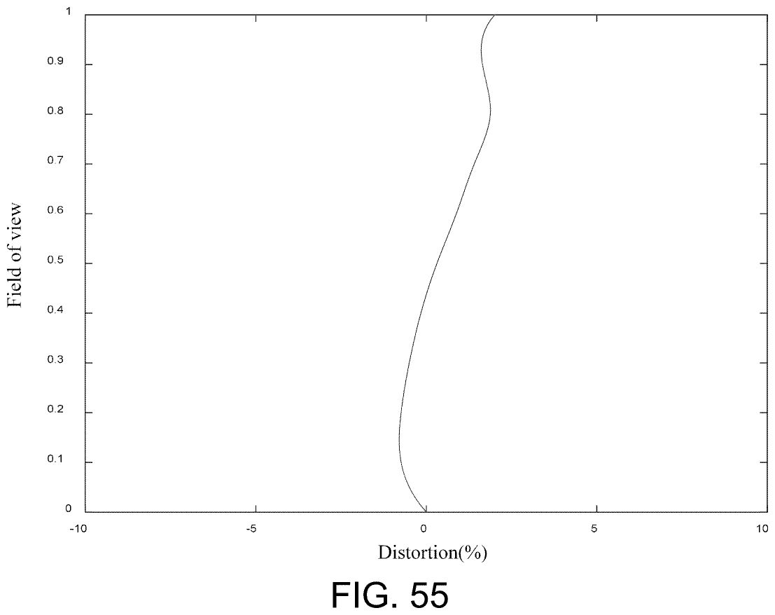

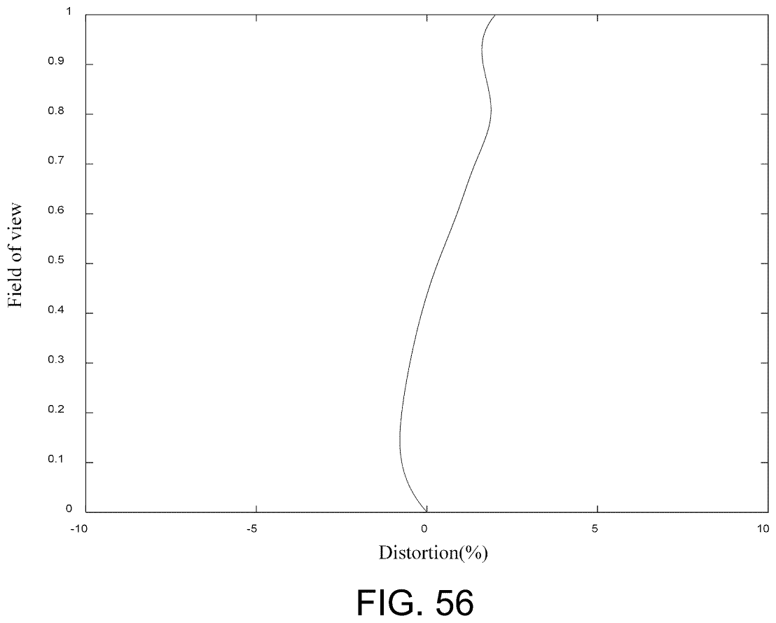

The specific parameters of the optical system provided by embodiment 9 are shown in Table 9-1. The curvature, thickness, refractive index, and other parameter items of each lens in the optical system are shown in Table 9-2. The aspherical coefficients of each surface of each lens in the optical system are shown in Table 9-3-1 and Table 9-3-2. FIG. 53 shows a phase modulation diagram of the metalens in the optical system provided by embodiment 9 at the wavelength of 486.13 nm, 587.56 nm, and 656.27 nm. It can be seen in FIG. 53 that the phases cover 0-2π of the metalens at different wavelengths. FIG. 54 shows an astigmatism diagram of the optical system. According to FIG. 54, the astigmatism of the optical system at different fields of view from 0 to 1 is less than 0.5 mm. FIG. 55 shows a distortion diagram of the optical system. According to FIG. 55, the distortion of the optical system at the different fields of view from 0 to 1 is less than 5%. FIG. 55 shows the matching degree of the wide spectrum of the metalens in the optical system in embodiment 9. According to FIG. 56, the real phase of embodiment 9 and the theoretical phase is greater than 90%. [0166] The optical system in embodiment 9 has a high MTF and has good control of astigmatism and distortion, therefore the optical system has good imaging quality.

TABLE 9-1

| Parameter item | Value | |
|---|---|---|
| Working wavelength(WL) | VIS(400-700 nm) | |
| Effective focal length(EFL) | 4 | mm |
| Field of view(2ω) | 66.4° | |
| F number | 2.85 | |
| Image height(ImgH) | 3.014 | mm |
| Total track length(TTL) | 4.0 | mm |

TABLE 9-2

| Numbered | | Radi- | Thick- | |
|---|---|---|---|---|
| surface | Surface type | us(mm) | ness(mm) | Material |
| L₁ₒ | Aspheric surface | 1.216 | 0.45 | 540000.560000 |
| L₁ᵢ | Aspheric surface | 4.355 | 0.0556 | |
| STO | Spherical surface | Infinite | 0.052 | |
| L₂ₒ | Structural surface | Infinite | 0.1 | 458000.676000 |
| | (metalens) | | | |
| L₂ᵢ | Spherical surface | Infinite | 0.0505 | |
| L₃ₒ | Aspheric surface | −71.74 | 0.233 | 634000.238000 |
| L₃ᵢ | Aspheric surface | 15.193 | 0.2489 | |
| L₄ₒ | Aspheric surface | −3.855 | 0.5032 | 544000.559000 |
| L₄ᵢ | Aspheric surface | −4.788 | 0.2965 | |
| L₅ₒ | Aspheric surface | −2.920 | 0.3455 | 544000.559000 |
| L₅ᵢ | Aspheric surface | −1.74 | 0.765 | |
| L₆ₒ | Aspheric surface | −1.457 | 0.200 | 544000.559000 |
| L₆ᵢ | Aspheric surface | 20.90 | 0.307 | |
| IR filterₒ | Spherical surface | Infinite | 0.145 | 517000.642000 |
| IR filterᵢ | Spherical surface | Infinite | 0.2474 | |
| Image plane | Spherical surface | Infinite | 0 | |

TABLE 9-3-1

| Numbered Surface | L₁ₒ | L₁ᵢ | L₃ₒ | L₃ᵢ | L₄ₒ | L₄ᵢ |
|---|---|---|---|---|---|---|
| K | −4.527127 | −4.527127 | −4.527127 | −4.527127 | −24.41537 | 9.4084642 |
| A | 0.3112751 | 0.3112751 | 0.3112751 | 0.3112751 | −0.17059 | −0.082783 |
| B | −0.241416 | −0.241416 | −0.241416 | −0.241416 | 0.0721652 | 0.0033925 |
| C | 0.2772688 | 0.2772688 | 0.2772688 | 0.2772688 | 0.3881643 | 0.1520774 |
| D | −0.142949 | −0.142949 | −0.142949 | −0.142949 | −0.55462 | −0.06382 |
| E | 0.0124238 | 0.0124238 | 0.0124238 | 0.0124238 | 0.2509785 | 0.0202773 |
| F | −0.116989 | −0.116989 | −0.116989 | −0.116989 | 0.2794401 | 0.0038956 |
| G | 0.1430622 | 0.1430622 | 0.1430622 | 0.1430622 | −0.578503 | −0.016386 |

TABLE 9-3-2

| | Numbered surface | | | |
|---|---|---|---|---|
| | L₅ₒ | L₅ᵢ | L₆ₒ | L₆ᵢ |
| K | 1.8911075 | −8.95372 | −0.28186 | −55836.57 |
| A | −0.102315 | −0.148997 | 0.0384629 | −0.067803 |
| B | 0.000209 | 0.1388092 | 0.0008724 | 0.0261372 |
| C | −0.180969 | −0.125707 | 0.0093502 | −0.009002 |
| D | 0.3159076 | 0.0685821 | −0.003484 | 0.0011236 |
| E | −0.176353 | −0.015608 | −0.000976 | −8.63E−05 |
| F | 0.0334863 | 0.0010858 | 9.34E−06 | 5.41E−05 |
| G | 0.0017692 | −0.000596 | 0.0001875 | −1.47E−05 |

### Embodiment 10

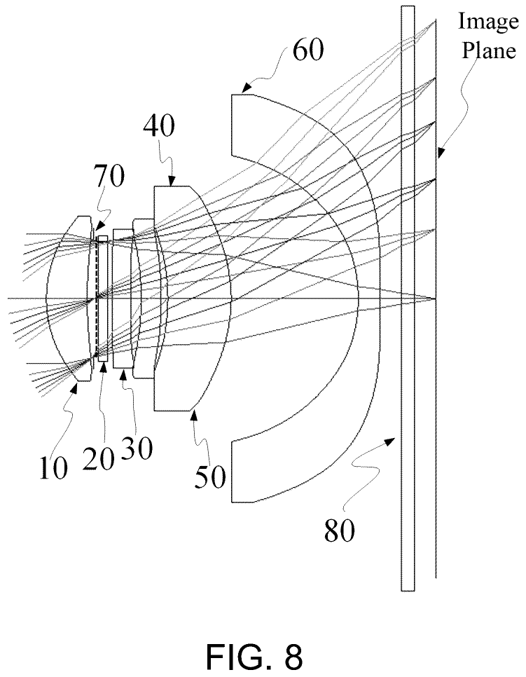

In one embodiment, embodiment 10 provides an optical system, and the optical system is shown in FIG. 8. The optical system in order from an object side to an image side, the six optical elements include: an aperture slot (STO) 70, a first lens 10, a second lens 20, a third lens 30, a fourth lens 40, a fifth lens 50 and a sixth lens 60. As shown in FIG. 8, the infrared filter is set between the sixth lens 60 and the image plane of the optical system. The optical system satisfies conditions (1-1)-(1-4):

$$f / EPD < 3 ; \qquad ( 1 - 1 )$$

$$25 ° \leq HFOV \leq 55 ° ; \qquad ( 1 - 2 )$$

$$0.05 mm \leq {d}_{2} \leq 2 mm ; \qquad ( 1 - 3 )$$

$$\vert {f}_{2} \vert / f \geq 10 ; \qquad ( 1 - 4 )$$

f is a focal length of the optical system; EPD is an entrance pupil diameter of the optical system; HFOV is a half of the maximum field of view; d₂ is a thickness of the second lens; f₂ is a focal length of the second lens.

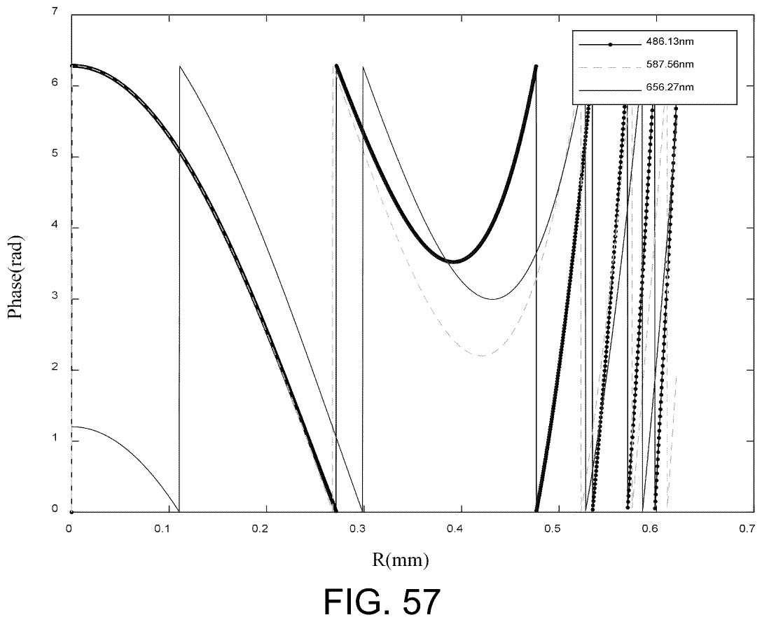

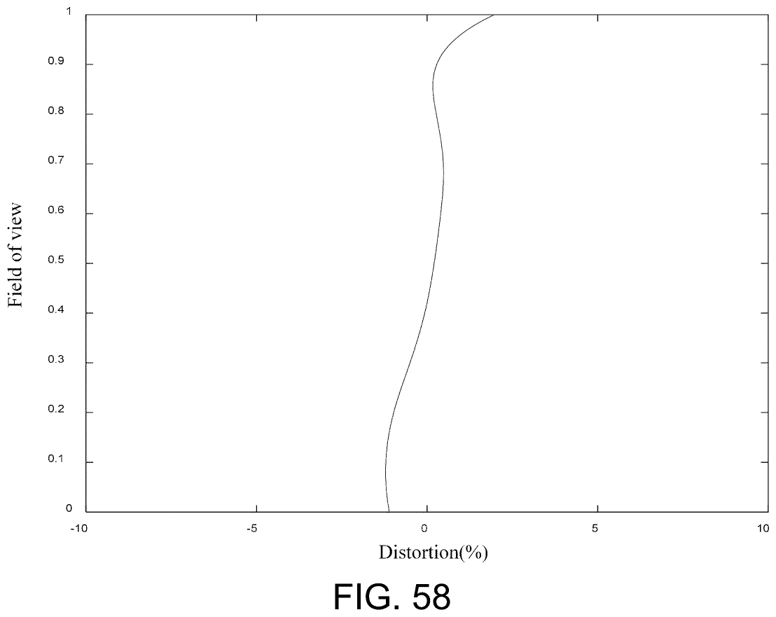

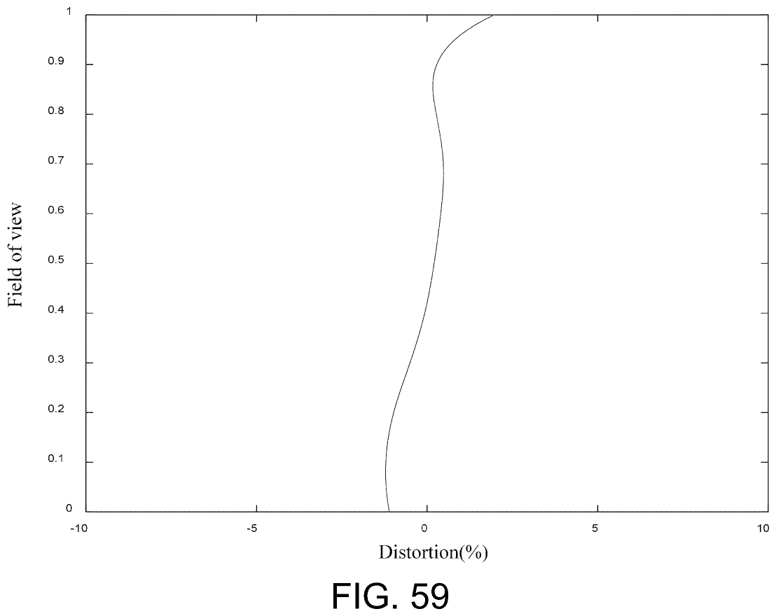

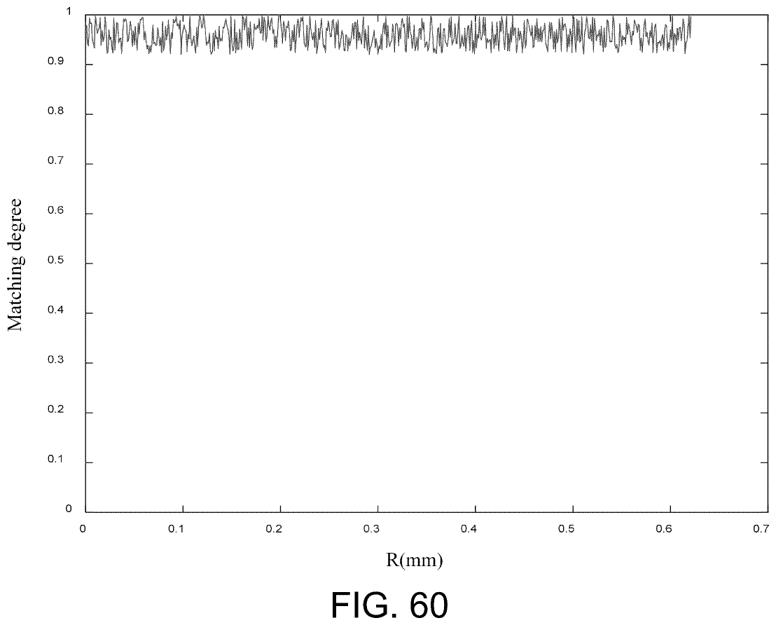

The specific parameters of the optical system provided by embodiment 10 are shown in Table 10-1. The curvature, thickness, refractive index, and other parameter items of each lens in the optical system are shown in Table 10-2. The aspherical coefficients of each surface of each lens in the optical system are shown in Table 10-3-1 and Table 10-3-2. FIG. 57 shows a phase modulation diagram of the metalens in the optical system provided by embodiment 10 at the wavelength of 486.13 nm, 587.56 nm, and 656.27 nm. It can be seen in FIG. 58 that the phases cover 0-2π of the metalens at different wavelengths. FIG. 58 shows an astigmatism diagram of the optical system. According to FIG. 58, the astigmatism of the optical system at different fields of view from 0 to 1 is less than 0.5 mm. FIG. 59 shows a distortion diagram of the optical system. According to FIG. 59, the distortion of the optical system at the different fields of view from 0 to 1 is less than 5%. FIG. 60 shows the matching degree of the wide spectrum of the metalens in the optical system in embodiment 10. According to FIG. 60, the real phase of embodiment 10 and the theoretical phase is greater than 90%. The optical system in embodiment 10 has a high MTF and has good control of astigmatism and distortion, therefore the optical system has good imaging quality.

TABLE 10-1

| Parameter item | Value | |
|---|---|---|
| Working wavelength(WL) | VIS(400-700 nm) | |
| Effective focal length(EFL) | 4 | mm |
| Field of view(2ω) | 66.4° | |
| F number | 2.85 | |
| Image height(ImgH) | 3.014 | mm |
| Total track length(TTL) | 4.2 | mm |

TABLE 10-2

| Numbered | | Radi- | Thick- | |
|---|---|---|---|---|
| surface | Surface type | us(mm) | ness(mm) | Material |
| L₁ₒ | Aspheric surface | 1.301 | 0.439 | 540000.560000 |
| L₁ᵢ | Aspheric surface | 4.023 | 0.0722 | |
| STO | Spherical surface | Infinite | 0.05 | |
| L₂ₒ | Structural surface | Infinite | 0.1 | 458000.676000 |
| | (metalens) | | | |
| L₂ᵢ | Spherical surface | Infinite | 0.05 | |
| L₃ₒ | Aspheric surface | 10.24 | 0.20 | 634000.238000 |
| L₃ᵢ | Aspheric surface | 8.200 | 0.11 | |
| L₄ₒ | Aspheric surface | −3.2581 | 0.2154 | 544000.559000 |
| L₄ᵢ | Aspheric surface | −3.8951 | 0.0706 | |
| L₅ₒ | Aspheric surface | −2.3544 | 0.6828 | 544000.559000 |
| L₅ᵢ | Aspheric surface | −1.7366 | 1.370 | |
| L₆ₒ | Aspheric surface | −1.631 | 0.2356 | 544000.559000 |
| L₆ᵢ | Aspheric surface | 27.44 | 0.225 | |
| IR filterₒ | Spherical surface | Infinite | 0.145 | 517000.642000 |
| IR filterᵢ | Spherical surface | Infinite | 0.2331 | |
| Image plane | Spherical surface | Infinite | 0 | |

TABLE 10-3-1

| Numbered Surface | L₁ₒ | L₁ᵢ | L₃ₒ | L₃ᵢ | L₄ₒ | L₄ᵢ |
|---|---|---|---|---|---|---|
| K | −4.930885 | −9.967591 | −2.48E+16 | −9.967591 | −19.73647 | −21.66745 |
| A | 0.2816075 | −0.03333 | −0.056678 | −0.03333 | −0.130666 | −0.061622 |
| B | −0.219687 | −0.00782 | 0.2996243 | −0.00782 | 0.0049981 | −0.093319 |
| C | 0.2763091 | −0.154566 | 0.1635329 | −0.154566 | 0.3531215 | 0.1416254 |
| D | −0.239358 | 0.3416499 | −0.823191 | 0.3416499 | −0.519927 | 0.1471917 |
| E | 0.0782505 | −0.331173 | 0.6670421 | −0.331173 | 0.3548887 | 0.1339349 |
| F | 0.1286909 | 0.020975 | −0.71871 | 0.020975 | 0.1946845 | −0.387356 |
| G | −0.204236 | 2.69E−09 | −2.83E−07 | 2.69E−09 | 0.1440297 | 0.2628043 |

TABLE 10-3-2

| | Numbered surface | | | |
|---|---|---|---|---|
| | L₅ₒ | L₅ᵢ | L₆ₒ | L₆ᵢ |
| K | −16.91132 | −7.037279 | −0.273635 | −32951.91 |
| A | −0.195216 | −0.14831 | −0.104358 | −0.096956 |
| B | 0.0789743 | 0.1313335 | 0.0351653 | 0.0340921 |
| C | −0.007882 | −0.098632 | 0.0186416 | −0.008377 |
| D | 0.1315148 | 0.0752048 | −0.015745 | 0.0010368 |
| E | −0.191226 | −0.025525 | −0.003201 | −0.000259 |
| F | 0.8238655 | −0.006899 | 0.004528 | 6.16E−05 |
| G | −1.021081 | 0.0017734 | −0.001074 | −5.50E−06 |

### Embodiment 11

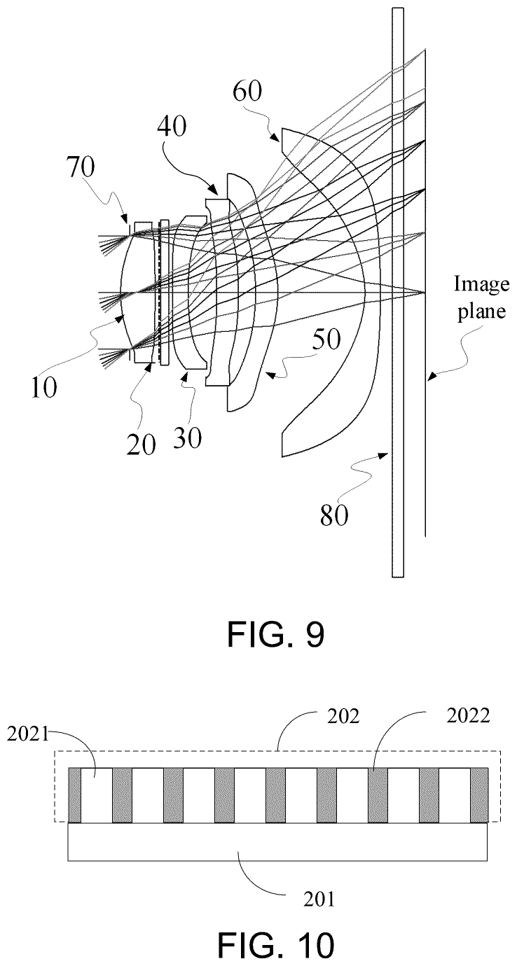

In one embodiment, embodiment 11 provides an optical system, and the optical system is shown in FIG. 9. The optical system in order from an object side to an image side, the six optical elements include: an aperture slot (STO) 70, a first lens 10, a second lens 20, a third lens 30, a fourth lens 40, a fifth lens 50 and a sixth lens 60. As shown in FIG. 9, the infrared filter is set between the sixth lens 60 and the image plane of the optical system. The optical system satisfies conditions (1-1)-(1-4):

$$f / EPD < 3 ; \qquad ( 1 - 1 )$$

$$25 ° \leq HFOV \leq 55 ° ; \qquad ( 1 - 2 )$$

$$0.05 mm \leq {d}_{2} \leq 2 mm ; \qquad ( 1 - 3 )$$

$$\vert {f}_{2} \vert / f \geq 10 ; \qquad ( 1 - 4 )$$

f is a focal length of the optical system; EPD is an entrance pupil diameter of the optical system; HFOV is a half of the maximum field of view; d₂ is a thickness of the second lens; f₂ is a focal length of the second lens.

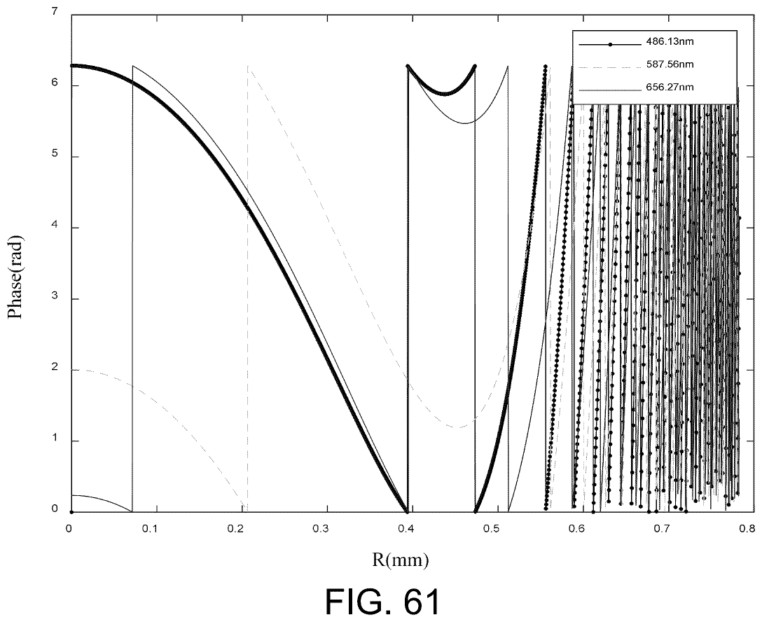

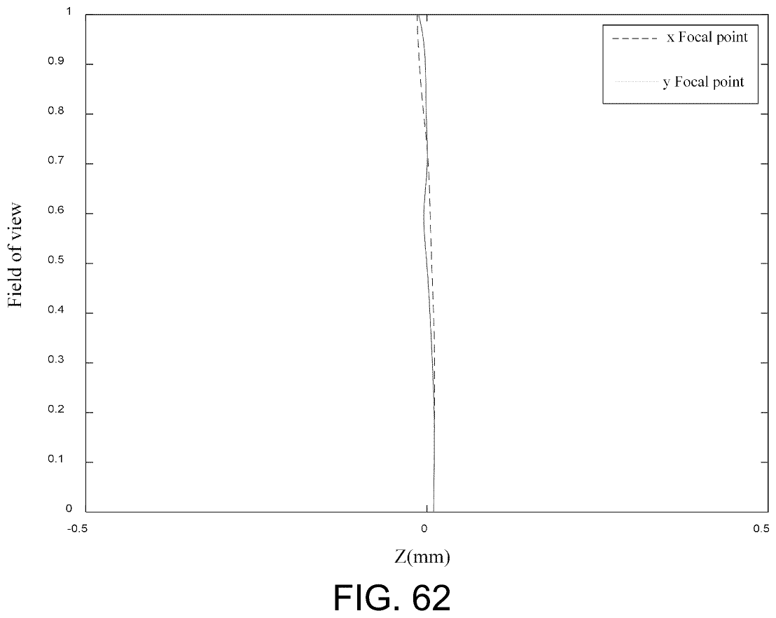

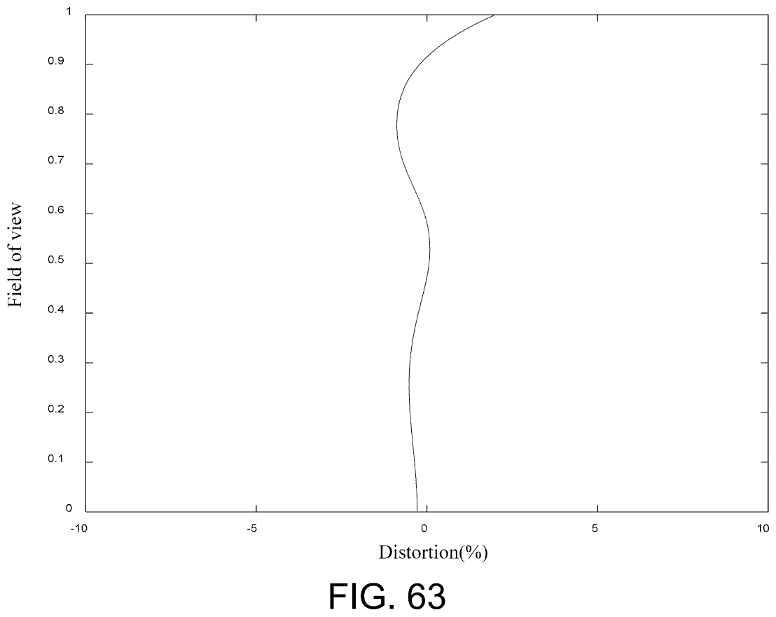

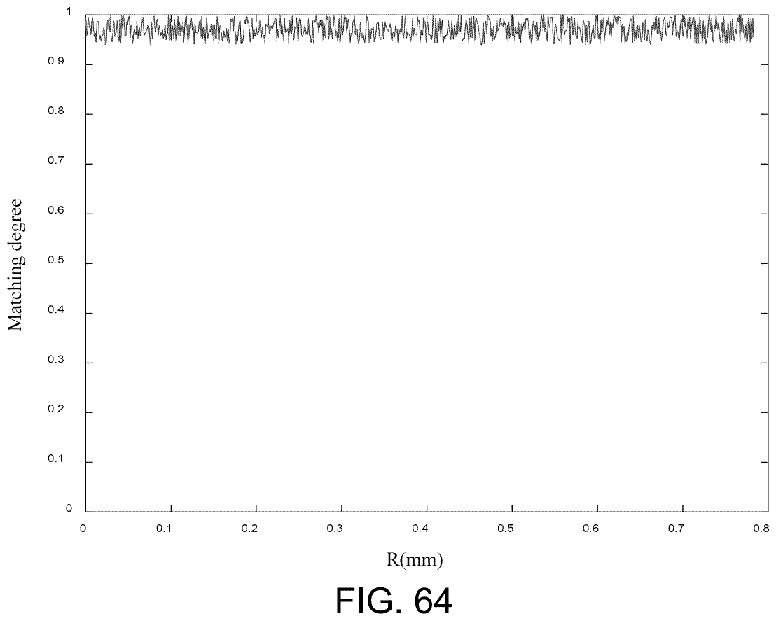

The specific parameters of the optical system provided by embodiment 11 are shown in Table 11-1. The curvature, thickness, refractive index, and other parameter items of each lens in the optical system are shown in Table 11-2. The aspherical coefficients of each surface of each lens in the optical system are shown in Table 11-3-1 and Table 11-3-2. FIG. 61 shows a phase modulation diagram of the metalens in the optical system provided by embodiment 11 at the wavelength of 486.13 nm, 587.56 nm, and 656.27 nm. It can be seen in FIG. 61 that the phases cover 0-2π of the metalens at different wavelengths. FIG. 62 shows an astigmatism diagram of the optical system. According to FIG. 62, the astigmatism of the optical system at different fields of view from 0 to 1 is less than 0.5 mm. FIG. 63 shows a distortion diagram of the optical system. According to FIG. 63, the distortion of the optical system at the different fields of view from 0 to 1 is less than 5%. FIG. 64 shows the matching degree of the wide spectrum of the metalens in the optical system in embodiment 11. According to FIG. 64, the real phase of embodiment 11 and the theoretical phase is greater than 90%. [0166] The optical system in embodiment 11 has a high MTF and has good control of astigmatism and distortion, therefore the optical system has good imaging quality.

TABLE 11-1

| Parameter item | Value | |
|---|---|---|
| Working wavelength(WL) | VIS(400-700 nm) | |
| Effective focal length(EFL) | 3.9 | mm |
| Field of view(2ω) | 74.4° | |
| F number | 2.85 | |
| Image height(ImgH) | 2.96 | mm |
| Total track length(TTL) | 3.9 | mm |

TABLE 11-2

| Numbered | | Radi- | Thick- | |
|---|---|---|---|---|
| surface | Surface type | us(mm) | ness(mm) | Material |
| L₁ₒ | Aspheric surface | Infinite | −0.12 | |
| L₁ᵢ | Aspheric surface | 1.434 | 0.44 | 540000.560000 |
| STO | Spherical surface | −43.356 | 0.074 | |
| L₂ₒ | Structural surface | Infinite | 0.1 | 458000.676000 |
| | (metalens) | | | |
| L₂ᵢ | Spherical surface | Infinite | 0.05 | |
| L₃ₒ | Aspheric surface | −70.26 | 0.20 | 634000.238000 |
| L₃ᵢ | Aspheric surface | 3.31 | 0.367 | |
| L₄ₒ | Aspheric surface | −7.275 | 0.2748 | 634000.238000 |
| L₄ᵢ | Aspheric surface | −5.021 | 0.2223 | |
| L₅ₒ | Aspheric surface | −2.356 | 0.2834 | 544000.559000 |
| L₅ᵢ | Aspheric surface | −1.500 | 1.1135 | |
| L₆ₒ | Aspheric surface | −1.1696 | 0.2 | 544000.559000 |
| L₆ᵢ | Aspheric surface | −8.238 | 0.1513 | |
| IR filterₒ | Spherical surface | Infinite | 0.145 | 517000.642000 |
| IR filterᵢ | Spherical surface | Infinite | 0.278 | |
| Image plane | Spherical surface | Infinite | 0 | |

TABLE 11-3-1

| Numbered Surface | L₁ₒ | L₁ᵢ | L₃ₒ | L₃ᵢ | L₄ₒ | L₄ᵢ |
|---|---|---|---|---|---|---|
| K | −6.54176 | 3111.7258 | −3.95E+19 | 5.9705123 | −112.5176 | −3.036169 |
| A | 0.247175 | −0.034502 | 0.056182 | 0.0669846 | −0.181038 | −0.151848 |
| B | −0.308841 | 0.0003362 | 0.0939926 | 0.1226945 | −0.012016 | −0.057479 |
| C | 0.3269658 | −0.175177 | 0.3113713 | 0.0720694 | 0.4452214 | 0.2332487 |
| D | −0.401455 | 0.2241798 | −0.828248 | −0.237591 | −0.430046 | −0.021204 |
| E | 0.1182199 | −0.284187 | 1.4603952 | 0.4599988 | 0.2744619 | 0.0242676 |
| F | 0.1391745 | 0.1055827 | −0.763345 | −0.127325 | −0.028087 | 7.49E−05 |
| G | −0.231066 | 9.60E−05 | −0.130187 | 0.1090679 | −0.118017 | −0.04288 |

TABLE 11-3-2

| | Numbered surface | | | |
|---|---|---|---|---|
| | L₅ₒ | L₅ᵢ | L₆ₒ | L₆ᵢ |
| K | −15.04539 | −5.696009 | −2.780013 | −113.4115 |
| A | −0.146435 | −0.087964 | 0.001517 | −0.016554 |
| B | 0.1148561 | 0.1642436 | −0.040839 | −0.004933 |
| C | −0.195972 | −0.125797 | 0.0074632 | −0.007158 |
| D | 0.2916657 | 0.0665997 | −0.001059 | 0.0024146 |
| E | −0.175865 | −0.01712 | 0.000584 | −0.000212 |
| F | 0.027464 | 0.0005325 | 0.000378 | 6.71E−06 |
| G | −0.003683 | −0.000604 | −0.00012 | −6.90E−06 |

In the third aspect, an imaging device is provided by the present application, the imaging device includes any optical system provided by the present application, and the imaging sensor set on the image plane of the optical system. Preferably, the imaging sensor is an electronic imaging sensor, for example, a CCD (Charge-Coupled Device) or a CMOS (Complementary Metal-Oxide-Semiconductor).

In the fourth aspect, an electronic device is provided by the present application, the electronic device includes the imaging device mentioned above.

It should be noted that the metalens provided by the embodiment of the present application can be processed through a semiconductor process and has the advantages of light weight, thin thickness, simple structure and process, low cost and high consistency in mass production.

In conclusion, in the optical system provided by the present application, the first lens is configured to be an aspheric refractive lens to provide main focal power of the whole optical system, and the second lens is configured to be a metalens. The other lenses are configured to be refractive lenses, and at least one surface of the other lenses is an aspheric surface. The length and weight of the six-lens optical system will be reduced by using the arrangement mode of “f/EPD<3; 25°≤HFOV≤55°; 0.05 mm≤d₂≤2 mm”, which realizes the miniaturization and lightweight of optical system.

The imaging device provided by the present application, the optical system provided by the present application has a smaller volume and a lighter weight, and better imaging effect, which is beneficial to combine the optical system with a larger size of the sensor and reduces the installation space of the optical system in the imaging device. In this way, the miniaturization and lightweight of the imaging device is realized.

The electronic device provided by the present application uses the imaging device provided by the application. Because the optical system in the present application has a smaller volume, lighter weight, and better imaging effect, it is beneficial to combine the optical system with the larger size of the sensor and reduce the installation space of the optical system in the imaging device. In this way, the electronic device reduces the volume and weight of the imaging device by using the imaging device, which realizes the miniaturization and lightweight of the imaging device.

The above is only a specific embodiment of the embodiments of this disclosure, but the scope of protection of the embodiment of this disclosure is not limited to this. And those skilled in the field can easily think of any change or substitution for this disclosure, which should be covered within the protection scope of this disclosure. Therefore, the scope of the protection of the present disclosure shall be the scope of the claims.

What is claimed is:

1. An optical system, the optical system comprising six optical elements, wherein in order from an object side to an image side, the six optical elements comprise: a first lens, a second lens, a third lens, a fourth lens, a fifth lens and a sixth lens;
each of six optical elements comprises an object-side surface facing towards the object plane and an image-side surface facing towards the image plane;
wherein the first lens is an aspheric refractive lens, and the second lens is a metalens; all the third lens, the fourth lens, the fifth lens and the sixth lens are refractive lenses;
and from the image side to the object side, there is at least one aspheric surface in the surfaces of the third lens, the fourth lens, the fifth lens and the sixth lens, and the aspheric surface has one point of inflection;
the first lens has a positive focal power, and the object-side surface of the first lens is a convex surface; the image-side surface of the third lens is a convex surface; the object-side surface of the fourth lens is a concave surface; both the curvature radius of object-side surface of fifth lens and the object-side surface of the sixth lens are negative;
the optical system satisfies the formulas as follows:
$$f / EPD < 3 ;$$
$$25 ° \leq HFOV \leq 55 ° ;$$
$$0.05 mm \leq {d}_{2} \leq 2 mm ;$$
$$\vert {f}_{2} \vert / f \geq 10 ;$$
wherein, f is a focal length of the optical system; EPD is an entrance pupil diameter of the optical system; HFOV is a half of the maximum field of view; d₂ is a thickness of the second lens; f₂ is a focal length of the second lens.

2. The optical system according to claim 1, wherein the optical system satisfies the following condition:
$$0.35 \leq {R}_{1 o} / {f}_{1} \leq 0 \text{.58} ;$$
wherein R₁ₒ is a curvature radius of the object-side surface of the first lens; f₁ is a focal length of the first lens.

3. The optical system according to claim 1, wherein the optical system satisfies the following condition:
$$( {V}_{1} + {V}_{4} ) / 2 - {V}_{3} > 20 ;$$
wherein, V₁ is an Abbe number of the first lens; V₃ is an Abbe number of the third lens; V₄ is an Abbe number of the fourth lens.

4. The optical system according to claim 1, wherein the optical system satisfies the following condition:
$$0.5 < TTL / ImgH < 0.82 ;$$
wherein TTL is a distance between the object-side of the first lens and a image plane of the optical system; ImgH is a maximum imaging height of the optical system.

5. The optical system according to claim 1, wherein the image-side of the fourth lens is a concave surface, and the optical system satisfies the following condition:
$${R}_{4 i} \times {R}_{4 o} > 0 ;$$
wherein R₄ₒ is a curvature radius of the object-side surface of the fourth lens; R₄; is a curvature radius of the image-side surface of the fourth lens.

6. The optical system according to claim 1, wherein a curvature radius of the image-side surface of the sixth lens is less than 0.

7. The optical system according to claim 1, wherein the first lens satisfies the following condition:
$$0.58 \leq {f}_{1} / f \leq 0 \text{.85} ;$$
wherein f₁ is a focal length of the first lens, and f is a focal length of the optical system.

8. The optical system according to claim 1, wherein there is at least one aspheric refractive lens in the third lens, the fourth lens, the fifth lens and the sixth lens.

9. The optical system according to claim 1, wherein the metalens comprises at least two nanostructured layers;
each of the nanostructured layers comprises a plurality of nanostructures;
the plurality of nanostructures in any two adjacent nanostructured layers are coaxial.

10. The optical system according to claim 1, wherein the metalens comprises at least two nanostructured layers; the nanostructures in any adjacent nanostructured layer are non-coaxial along a direction parallel with the substrate.

11. The optical system according to claim 9, wherein a period of the nanostructures in any nanostructured layers is greater than or equal to 0.3λ_{c}, and is less than or equal to 2λ_{c};
wherein, λ_{c} is a central wavelength of the second lens at the working waveband.

12. The optical system according to claim 9, wherein a height of the nanostructures in any nanostructured layer is greater than or equal to 0.3λ_{c}, and is less than or equal to 2λ_{c};
wherein, λ_{c} is a central wavelength of the second lens at the working waveband.

13. The optical system according to claim 9, wherein the metalens further comprises an antireflection film;
the antireflection film is set on at least one side of the substrate.

14. The optical system according to claim 9, wherein the plurality of nanostructures are polarization-independent structures.

15. The optical system according to claim 14, wherein the polarization-independent structures comprise cylinder structures, hollow structures, cylindrical structures, round-hole structures, hollow-round-hole structures, square column structures, square hole structures, hollow square column structures and hollow square hole structures.

16. The optical system according to claim 1, wherein a working waveband of the optical system comprises a visible waveband.

17. A manufacturing method for a metalens, wherein the manufacturing method is used to manufacture the metalens of the optical system claimed as claim 2, and the manufacturing method comprises:
S1. setting a structural material layer on the substrate;
S2. coating a photo-resist on the structural material layer, and exposing and obtaining a reference structure;
S3, etching the structural material layer into the nanostructures arranged in period according to the reference structure, so as to form the nanostructured layer;
S4. filling a filler material between the nanostructures;
S5. polishing a surface of the filler material, so as to make the surface of the filler material align with the surface of the nanostructures.

18. The manufacturing method for a metalens according to claim 17, wherein the manufacturing method further comprises:
S6. repeating S1 to S5, until completing all the nanostructured layers.

19. An imaging device, wherein the imaging device comprises the optical system claimed as claim 1 and an image sensor; the image sensor is set on the image plane of the optical system.

20. An electronic device, wherein the electronic device comprise the imaging device claimed as claim 19.
